(19) United States
(12) Patent Application Publication
(10) Pub. No.: US 2024/0023109 A1
(43) Pub. Date: Jan. 18, 2024

(54) CONFIGURED GRANT SIDELINK COMMUNICATIONS IN A SHARED OR UNLICENSED FREQUENCY BAND

(71) Applicant: QUALCOMM Incorporated, San Diego, CA (US)

(72) Inventors: Sherif ELAZZOUNI, San Diego, CA (US); Ozcan OZTURK, San Diego, CA (US); Piyush GUPTA, Bridgewater, NJ (US); Jing SUN, San Diego, CA (US); Qing LI, Princeton Junction, NJ (US); Junyi LI, Fairless Hills, PA (US)

(21) Appl. No.: 17/812,228

(22) Filed: Jul. 13, 2022

(51) Int. Cl. H04W 72/14; H04L 1/18

(52) U.S. Cl. CPC H04W 72/14; H04L 1/1848

(57) ABSTRACT

Various aspects of the present disclosure generally relate to wireless communication. In some aspects, a user equipment (UE) may perform a channel access procedure associated with a transmission of a sidelink communication that is to be associated with resources that are associated with a first configured grant configuration, wherein the channel access procedure is unsuccessful, wherein the sidelink communication is associated with a hybrid automatic repeat request (HARQ) process identifier, and wherein a state associated with the HARQ process identifier is changed to pending based on the channel access procedure being unsuccessful. The UE may transmit, based on successfully performing another channel access procedure, a retransmission of the sidelink communication using resources associated with the first configured grant configuration or a second configured grant configuration based on the state associated with the HARQ process identifier being changed to pending. Numerous other aspects are described.

### FIELD OF THE DISCLOSURE

Aspects of the present disclosure generally relate to wireless communication and to techniques and apparatuses for configured grant (CG) sidelink communications in a shared or unlicensed frequency band.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

Some aspects described herein relate to a user equipment (UE) for wireless communication. The UE may include a memory and one or more processors coupled to the memory. The one or more processors may be configured to cause the UE to perform a channel access procedure associated with a transmission of a sidelink communication that is to be associated with resources that are associated with a first configured grant configuration, wherein the channel access procedure is unsuccessful, wherein the sidelink communication is associated with a hybrid automatic repeat request (HARQ) process identifier, and wherein a state associated with the HARQ process identifier is changed to pending based at least in part on the channel access procedure being unsuccessful. The one or more processors may be configured to cause the UE to transmit, based at least in part on successfully performing another channel access procedure, a retransmission of the sidelink communication using resources associated with the first configured grant configuration or a second configured grant configuration based at least in part on the state associated with the HARQ process identifier being changed to pending.

Some aspects described herein relate to a network node for wireless communication. The network node may include a memory and one or more processors coupled to the memory. The one or more processors may be configured to cause the network node to transmit, to a first UE, configuration information indicating that hybrid HARQ process sharing is enabled and indicating information associated with one or more timers associated with the HARQ process sharing, wherein the configuration information indicates information associated with at least one of a first configured grant configuration or a second configured grant configuration. The one or more processors may be configured to cause the network node to receive, from the first UE, feedback information associated with a sidelink communication that is associated with the first configured grant configuration, wherein the sidelink communication was transmitted via the second configured grant configuration.

Some aspects described herein relate to a method of wireless communication performed by a UE. The method may include performing a channel access procedure associated with a transmission of a sidelink communication that is to be associated with resources that are associated with a first configured grant configuration, wherein the channel access procedure is unsuccessful, wherein the sidelink communication is associated with a HARQ process identifier, and wherein a state associated with the HARQ process identifier is changed to pending based at least in part on the channel access procedure being unsuccessful. The method may include transmitting, based at least in part on successfully performing another channel access procedure, a retransmission of the sidelink communication using resources associated with the first configured grant configuration or a second configured grant configuration based at least in part on the state associated with the HARQ process identifier being changed to pending.

Some aspects described herein relate to a method of wireless communication performed by a network node. The method may include transmitting, to a first UE, configuration information indicating that HARQ process sharing is enabled and indicating information associated with one or more timers associated with the HARQ process sharing, wherein the configuration information indicates information associated with at least one of a first configured grant configuration or a second configured grant configuration. The method may include receiving, from the first UE, feedback information associated with a sidelink communication that is associated with the first configured grant configuration, where the sidelink communication was transmitted via the second configured grant configuration.

Some aspects described herein relate to a non-transitory computer-readable medium that stores a set of instructions for wireless communication by a UE. The set of instructions, when executed by one or more processors of the UE, may cause the UE to perform a channel access procedure associated with a transmission of a sidelink communication that is to be associated with resources that are associated with a first configured grant configuration, wherein the channel access procedure is unsuccessful, wherein the sidelink communication is associated with a HARQ process identifier, and wherein a state associated with the HARQ process identifier is changed to pending based at least in part on the channel access procedure being unsuccessful. The set of instructions, when executed by one or more processors of the UE, may cause the UE to transmit, based at least in part on successfully performing another channel access procedure, a retransmission of the sidelink communication using resources associated with the first configured grant configuration or a second configured grant configuration based at least in part on the state associated with the HARQ process identifier being changed to pending.

Some aspects described herein relate to a non-transitory computer-readable medium that stores a set of instructions for wireless communication by a network node. The set of instructions, when executed by one or more processors of the network node, may cause the network node to transmit, to a first UE, configuration information indicating that HARQ process sharing is enabled and indicating information associated with one or more timers associated with the HARQ process sharing, wherein the configuration information indicates information associated with at least one of a first configured grant configuration or a second configured grant configuration. The set of instructions, when executed by one or more processors of the network node, may cause the network node to receive, from the first UE, feedback information associated with a sidelink communication that is associated with the first configured grant configuration, wherein the sidelink communication was transmitted via the second configured grant configuration.

Some aspects described herein relate to an apparatus for wireless communication. The apparatus may include means for performing a channel access procedure associated with a transmission of a sidelink communication that is to be associated with resources that are associated with a first configured grant configuration, wherein the channel access procedure is unsuccessful, wherein the sidelink communication is associated with a HARQ process identifier, and wherein a state associated with the HARQ process identifier is changed to pending based at least in part on the channel access procedure being unsuccessful. The apparatus may include means for transmitting, based at least in part on successfully performing another channel access procedure, a retransmission of the sidelink communication using resources associated with the first configured grant configuration or a second configured grant configuration based at least in part on the state associated with the HARQ process identifier being changed to pending.

Some aspects described herein relate to an apparatus for wireless communication. The apparatus may include means for transmitting, to a first UE, configuration information indicating that HARQ process sharing is enabled and indicating information associated with one or more timers associated with the HARQ process sharing, wherein the configuration information indicates information associated with at least one of a first configured grant configuration or a second configured grant configuration. The apparatus may include means for receiving, from the first UE, feedback information associated with a sidelink communication that is associated with the first configured grant configuration, wherein the sidelink communication was transmitted via the second configured grant configuration.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIG. 5 is a diagram illustrating an example of configured grant (CG) communication, in accordance with the present disclosure.

FIG. 6 is a diagram illustrating an example of sidelink communication in a shared or unlicensed frequency band, in accordance with the present disclosure.

FIGS. 7A and 7B are diagrams of an example associated with configured grant sidelink communications in a shared or unlicensed frequency band, in accordance with the present disclosure.

FIG. 8 is a diagram of an example associated with modifying a state of a HARQ process identifier, in accordance with the present disclosure.

FIG. 9 is a diagram of an example associated with timers that are associated with configured grant sidelink communications in a shared or unlicensed frequency band, in accordance with the present disclosure.

FIG. 10 is a diagram of an example associated with network feedback associated with configured grant sidelink communications in a shared or unlicensed frequency band, in accordance with the present disclosure.

FIG. 11 is a diagram of an example associated with one-shot feedback associated with configured grant sidelink communications in a shared or unlicensed frequency band, in accordance with the present disclosure.

FIG. 12 is a diagram of an example associated with one-shot feedback associated with configured grant sidelink communications in a shared or unlicensed frequency band, in accordance with the present disclosure.

FIG. 13 is a diagram of an example associated with one-shot feedback associated with configured grant sidelink communications in a shared or unlicensed frequency band, in accordance with the present disclosure.

FIG. 14 is a diagram illustrating an example process performed, for example, by a UE, in accordance with the present disclosure.

FIG. 15 is a diagram illustrating an example process performed, for example, by a network node, in accordance with the present disclosure.

FIG. 16 is a diagram of an example apparatus for wireless communication, in accordance with the present disclosure.

FIG. 17 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

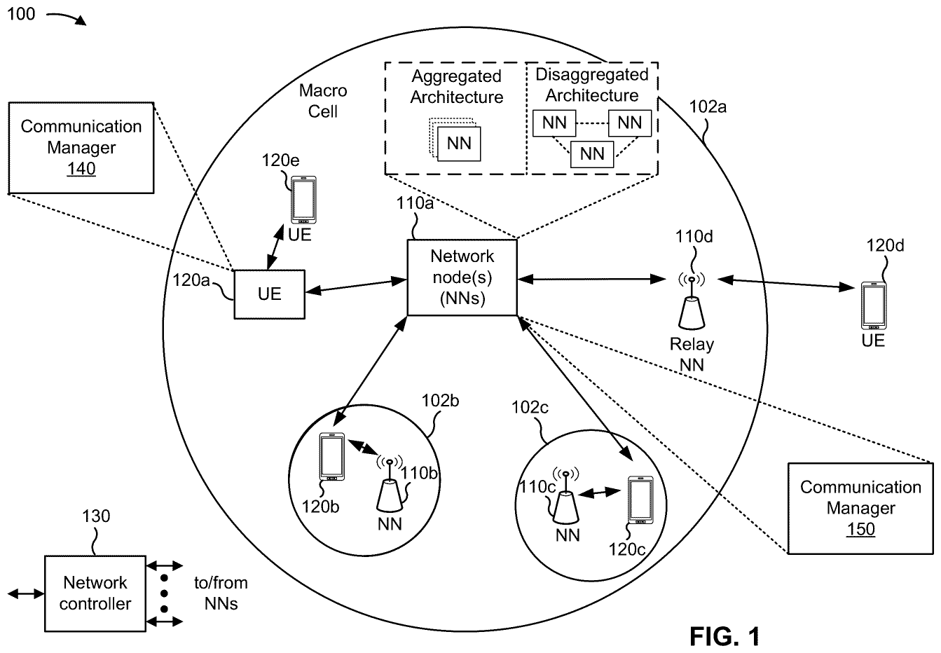

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) MC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With these examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may perform a channel access procedure associated with a transmission of a sidelink communication that is to be associated with resources that are associated with a first configured grant configuration, wherein the channel access procedure is unsuccessful, wherein the sidelink communication is associated with a hybrid automatic repeat request (HARQ) process identifier, and wherein a state associated with the HARQ process identifier is changed to pending based at least in part on the channel access procedure being unsuccessful; and transmit, based at least in part on successfully performing another channel access procedure, a retransmission of the sidelink communication using resources associated with the first configured grant configuration or a second configured grant configuration based at least in part on the state associated with the HARQ process identifier being changed to pending. Additionally, or alternatively, the communication manager 140 may perform one or more other operations described herein.

In some aspects, the network node 110 may include a communication manager 150. As described in more detail elsewhere herein, the communication manager 150 may transmit, to a first UE, configuration information indicating that HARQ process sharing is enabled and indicating information associated with one or more timers associated with the HARQ process sharing, wherein the configuration information indicates information associated with at least one of a first configured grant configuration or a second configured grant configuration; and receive, from the first UE, feedback information associated with a sidelink communication that is associated with the first configured grant configuration, wherein the sidelink communication was transmitted via the second configured grant configuration. Additionally, or alternatively, the communication manager 150 may perform one or more other operations described herein.

As indicated above, FIG. 1 is provided as an example. Other examples may differ from what is described with regard to FIG. 1.

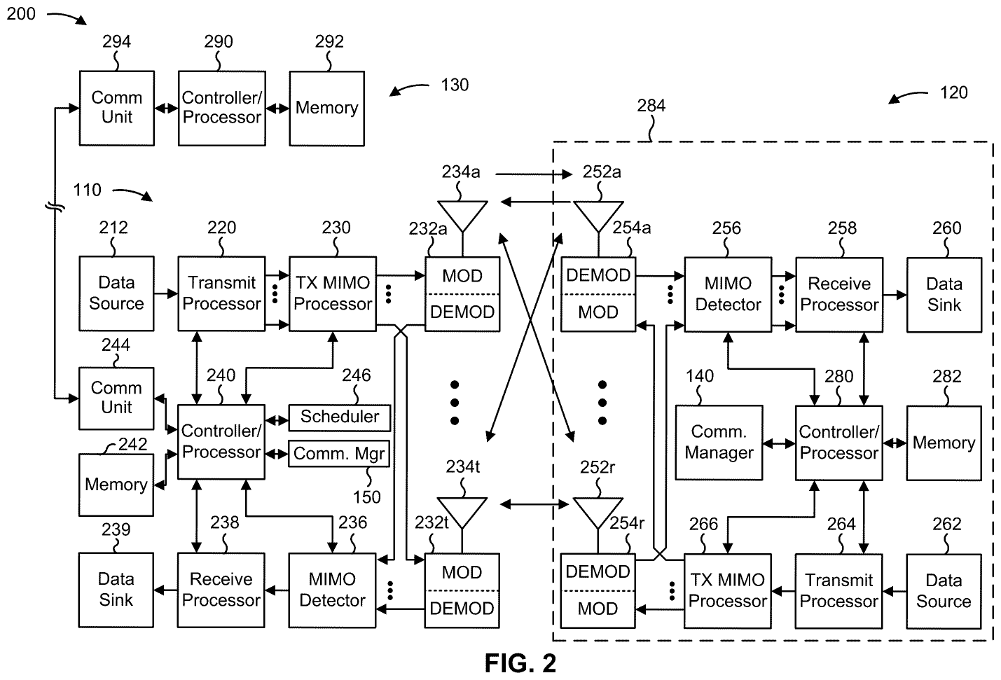

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MC S(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

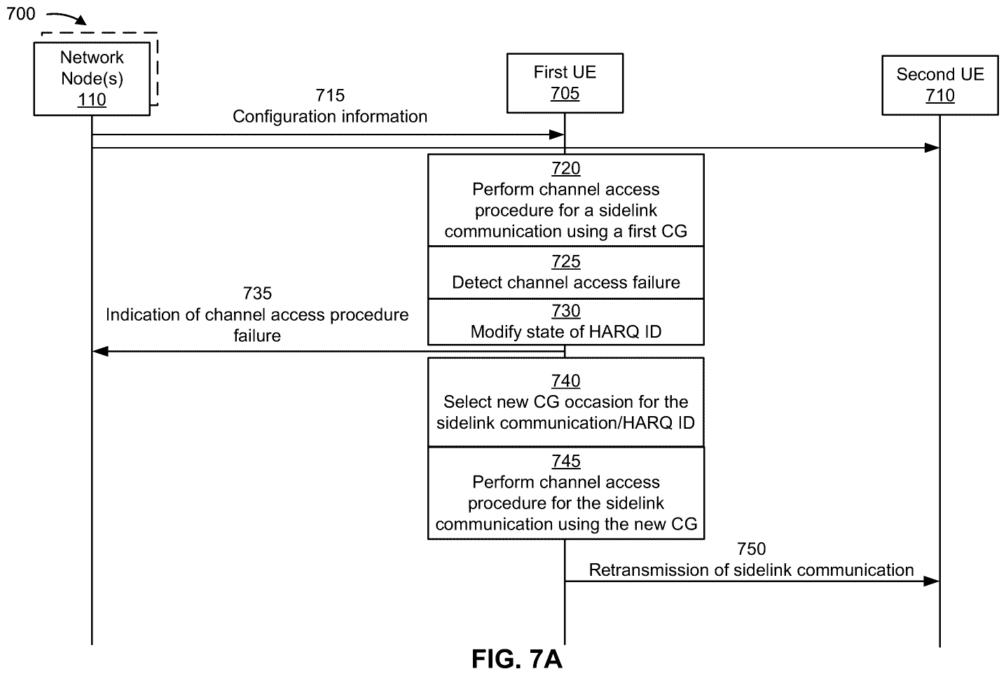

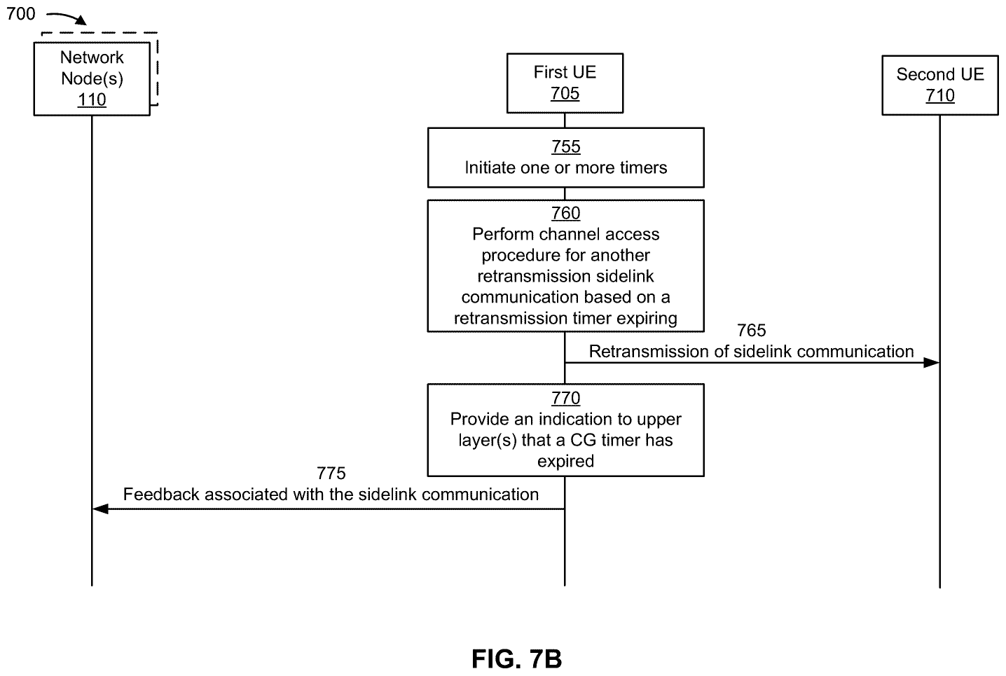

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein (e.g., with reference to FIGS. 7A, 7B, and 8-17).

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein (e.g., with reference to FIGS. 7A, 7B, and 8-17).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

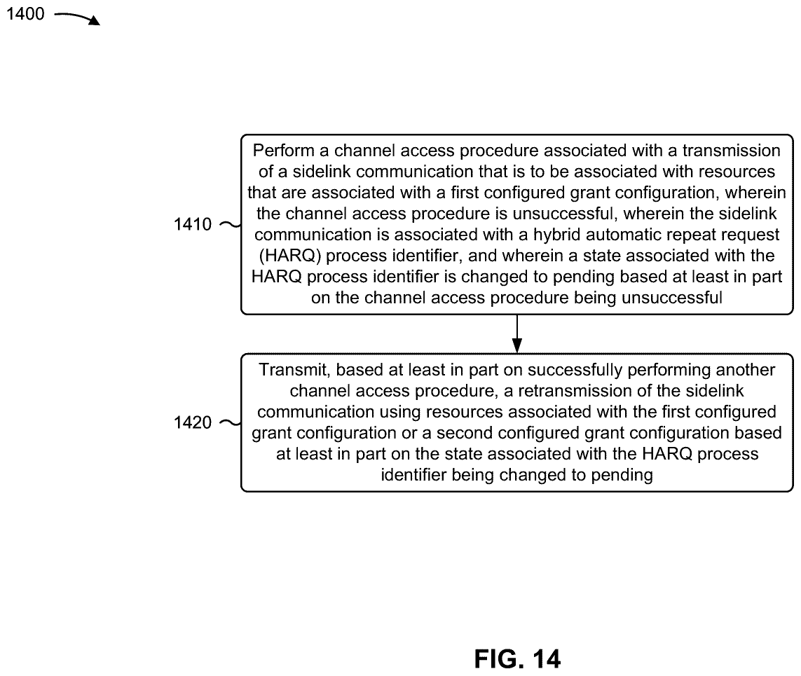

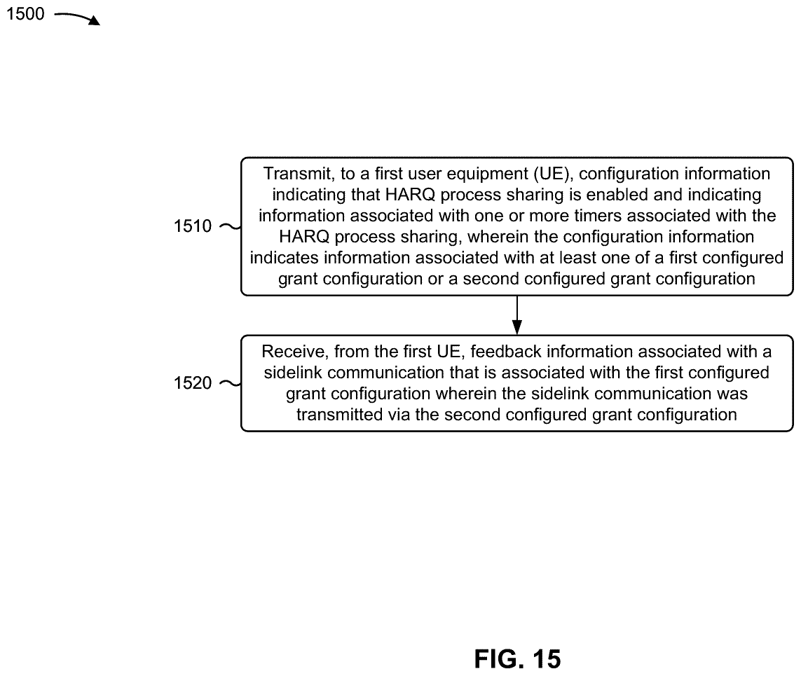

The controller/processor 240 of the network node 110, the controller/processor 280 of the UE 120, or any other component(s) of FIG. 2 may perform one or more techniques associated with configured grant sidelink communications in a shared or unlicensed frequency band, as described in more detail elsewhere herein. For example, the controller/processor 240 of the network node 110, the controller/processor 280 of the UE 120, or any other component(s) (or combinations of components) of FIG. 2 may perform or direct operations of, for example, process 1400 of FIG. 14, process 1500 of FIG. 15, and/or other processes as described herein. The memory 242 and the memory 282 may store data and program codes for the network node 110 and the UE 120, respectively. In some examples, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 1400 of FIG. 14, process 1500 of FIG. 15, and/or other processes as described herein. In some examples, executing instructions may include running the instructions, converting the instructions, compiling the instructions, and/or interpreting the instructions, among other examples.

In some aspects, the UE 120 includes means for performing a channel access procedure associated with a transmission of a sidelink communication that is to be associated with resources that are associated with a first configured grant configuration, wherein the channel access procedure is unsuccessful, wherein the sidelink communication is associated with a HARQ process identifier, and wherein a state associated with the HARQ process identifier is changed to pending based at least in part on the channel access procedure being unsuccessful; and/or means for transmitting, based at least in part on successfully performing another channel access procedure, a retransmission of the sidelink communication using resources associated with the first configured grant configuration or a second configured grant configuration based at least in part on the state associated with the HARQ process identifier being changed to pending. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting, to a first UE, configuration information indicating that HARQ process sharing is enabled and indicating information associated with one or more timers associated with the HARQ process sharing, wherein the configuration information indicates information associated with at least one of a first configured grant configuration or a second configured grant configuration; and/or means for receiving, from the first UE, feedback information associated with a sidelink communication that is associated with the first configured grant configuration, wherein the sidelink communication was transmitted via the second configured grant configuration. In some aspects, the means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

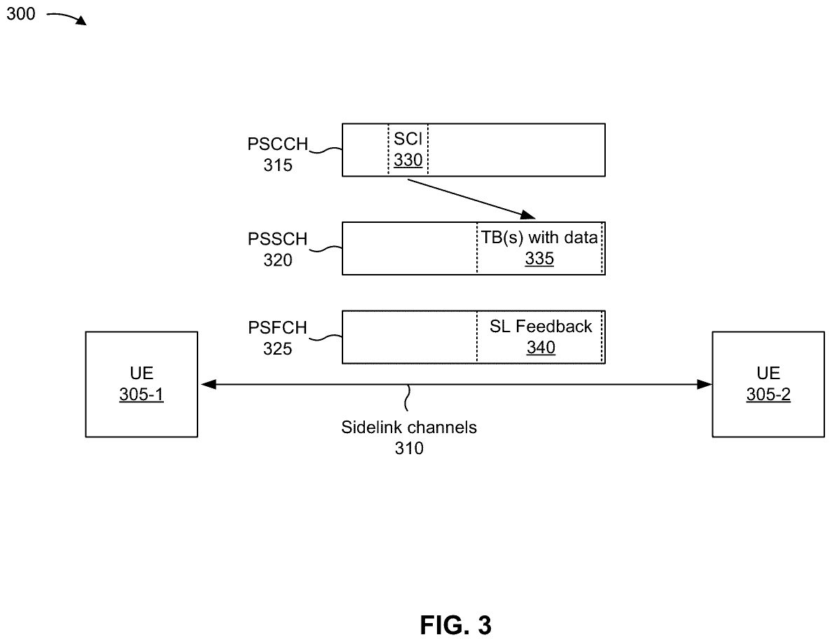

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V21 communications, and/or V2P communications) and/or mesh networking. In some examples, the UEs 305 (e.g., UE 305-1 and/or UE 305-2) may correspond to one or more other UEs described elsewhere herein, such as UE 120. In some examples, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a network node 110 (e.g., an RU) via an access link or an access channel. The PSSCH 320 may be used to communicate data, similar to a physical downlink shared channel (PDSCH) and/or a physical uplink shared channel (PUSCH) used for cellular communications with a network node 110 (e.g., an RU) via an access link or an access channel. For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as HARQ feedback (e.g., acknowledgement or negative acknowledgement (ACK/NACK) information), transmit power control (TPC), and/or a scheduling request (SR).

Although shown on the PSCCH 315, in some examples, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QoS) priority value, a resource reservation period, a PSSCH DMRS pattern, an SCI format for the SCI-2, a beta offset for the SCI-2, a quantity of PSSCH DMRS ports, and/or an MCS. The SCI-2 may include information associated with data transmissions on the PSSCH 320, such as a HARQ process ID, a new data indicator (NDI), a source identifier, a destination identifier, and/or a channel state information (CSI) report trigger.

In some examples, the one or more sidelink channels 310 may use resource pools. For example, a scheduling assignment (e.g., included in SCI 330) may be transmitted in sub-channels using specific resource blocks (RBs) across time. In some examples, data transmissions (e.g., on the PSSCH 320) associated with a scheduling assignment may occupy adjacent RBs in the same subframe as the scheduling assignment (e.g., using frequency division multiplexing). In some examples, a scheduling assignment and associated data transmissions are not transmitted on adjacent RBs.

In some examples, a UE 305 may operate using a sidelink transmission mode (e.g., Mode 1) where resource selection and/or scheduling is performed by a network node 110 (e.g., a DU or a CU). For example, the UE 305 may receive a grant (e.g., in downlink control information (DCI) or in a radio resource control (RRC) message, such as for configured grants) from the network node 110 (e.g., directly or via one or more network nodes) for sidelink channel access and/or scheduling. In some other examples, a UE 305 may operate using a transmission mode (e.g., Mode 2) where resource selection and/or scheduling is performed by the UE 305 (e.g., rather than a network node 110). In some examples, the UE 305 may perform resource selection and/or scheduling by sensing channel availability for transmissions. For example, the UE 305 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy ratio or channel busy rate associated with various sidelink channels, which may be used for rate control (e.g., by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or an MCS to be used for the upcoming sidelink transmission. In some examples, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

HARQ feedback provides a mechanism for indicating, to a transmitter of a communication, whether the communication was successfully received. For example, the transmitter may transmit scheduling information for the communication. A receiver of the scheduling information may monitor resources indicated by the scheduling information in order to receive the communication. If the receiver successfully receives the communication, the receiver may transmit an ACK in HARQ feedback. If the receiver fails to receive the communication, the receiver may transmit a negative acknowledgement (NACK) in HARQ feedback. Thus, based at least in part on the HARQ feedback, the transmitter can determine whether the communication should be retransmitted. HARQ feedback is often implemented using a single bit, where a first value of the bit indicates an ACK and a second value of the bit indicates a NACK. Such a bit may be referred to as a HARQ-ACK bit. HARQ-ACK feedback may be conveyed in a HARQ codebook, which may include one or more bits indicating ACKs or NACKs corresponding to one or more communications.

In some examples, a UE 120 may provide HARQ feedback to a network node 110 or another UE 120 for one or more HARQ processes. In some cases, if the network node 110 or the other UE 120 does not receive the HARQ feedback, the network node 110 or the other UE 120 may request a HARQ codebook indicating HARQ feedback for multiple (or all) downlink HARQ processes in one full HARQ report (e.g., one-shot feedback). In some examples, the network node 110 may include the request in a downlink grant. For example, the UE 120 may transmit one-shot feedback over a Uu link as a Type-3 HARQ codebook (e.g., as defined, or otherwise fixed, by a wireless communication standard, such as the 3GPP). For example, a Type-3 HARQ codebook may be associated with multiple HARQ processes (e.g., multiple HARQ process identifiers). The UE 120 also may transmit the Type-3 HARQ codebook over a sidelink for shared or unlicensed bands. The UE 120 may transmit the Type-3 HARQ codebook in SCI, over multiple PSFCH opportunities, or by using index modulation.

As indicated above, FIG. 3 is provided as an example. Other examples may differ from what is described with respect to FIG. 3.

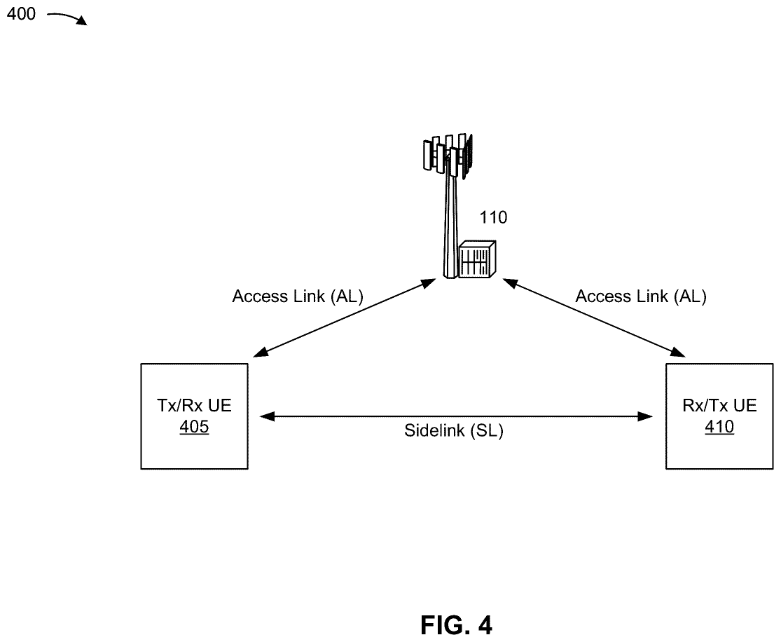

FIG. 4 is a diagram illustrating an example 400 of sidelink communications and access link communications, in accordance with the present disclosure.

As shown in FIG. 4, a transmitter (Tx)/receiver (Rx) UE 405 and an Rx/Tx UE 410 may communicate with one another via a sidelink, as described above in connection with FIG. 3. As further shown, in some sidelink modes, a network node 110 may communicate with the Tx/Rx UE 405 via a first access link (e.g., directly or via one or more network nodes). Additionally, or alternatively, in some sidelink modes, the network node 110 may communicate with the Rx/Tx UE 410 via a second access link (e.g., directly or via one or more network nodes). The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a network node 110 (e.g., an RU) and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

As indicated above, FIG. 4 is provided as an example. Other examples may differ from what is described with respect to FIG. 4.

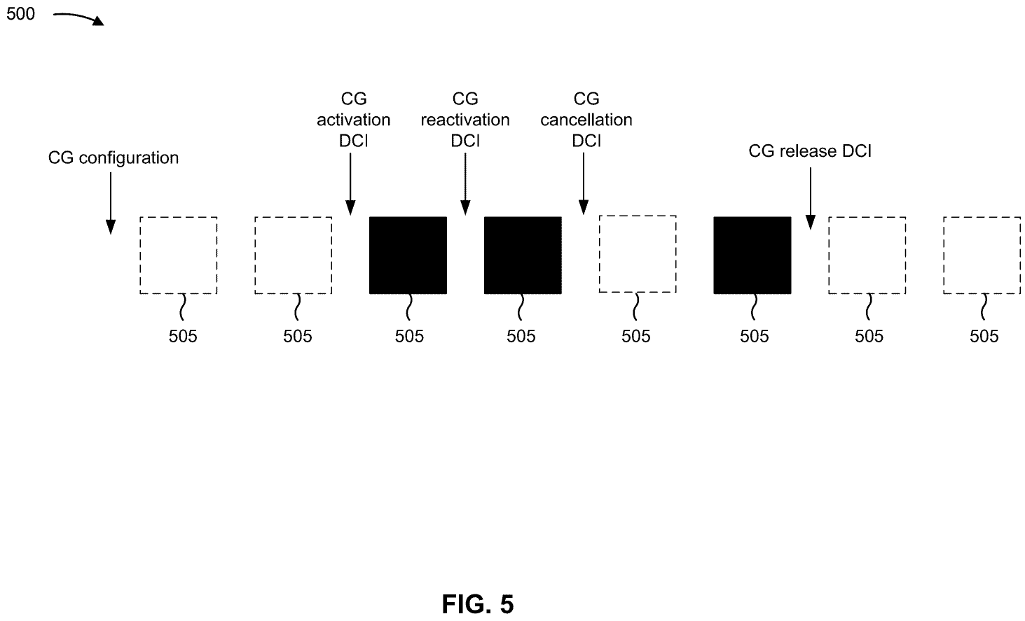

FIG. 5 is a diagram illustrating an example 500 of configured grant (CG) communication, in accordance with the present disclosure. CG communications may include periodic sidelink communication opportunities that are configured for a UE, such that a network node does not need to send separate DCI to schedule each sidelink communication (e.g., in a sidelink Mode 1), thereby conserving signaling overhead.

For example, a network node 110 may utilize configured grants for scheduling and/or allocating resources for sidelink communications. In some examples, prior to traffic arrival at a transmitting UE, the transmitting UE may request a set of resources for sidelink communications. If a grant can be obtained from the network node 110, then the requested resources are reserved in a periodic manner. In some examples, the network node 110 may configure the transmitting UE with periodic CG occasions (e.g., sidelink transmission opportunities). Each CG occasion may be associated with the resources granted by a network node 110 (e.g., specifying specific periodic slots in the time domain and/or specific sub-channels in the frequency domain for sidelink communications). Upon traffic arriving at a transmitting UE, the transmitting UE can transmit a PSCCH and/or a PSSCH in an upcoming CG occasion. In some examples, the transmitting UE may report a CG sidelink transmission to the network node 110 to request a dynamic grant for retransmissions. As another example, a configured grant configuration may indicate one or more resources (e.g., transmission opportunities) for a retransmission of a sidelink communication that was transmitted using a configured grant occasion. As used herein, an “occasion” may refer to a transmission opportunity that is associated with one or more time-frequency resources. Additionally, or alternatively, the transmitting UE may report a CG sidelink transmission to the network node 110 such that the network node 110 may perform channel congestion control for the sidelink network.

Utilizing CG resource allocation may reduce a signaling overhead for the sidelink network. Additionally, the CG resource allocation may enable the network node 110 to coordinate channel access to avoid collisions of transmissions among the UEs that may occur based at least in part on using Mode 1 channel access or Mode 2 channel access.

As shown in example 500, a UE 120 may be configured with a CG configuration for CG communications. For example, the UE 120 may receive the CG configuration via an RRC message. The CG configuration may indicate a resource allocation associated with CG occasions (e.g., in a time domain, frequency domain, spatial domain, and/or code domain) and a periodicity at which the resource allocation is repeated, resulting in periodically reoccurring scheduled CG occasions 505 for the UE. In some examples, the CG configuration may identify a resource pool or multiple resource pools that are available to the UE for a sidelink transmission. The CG configuration may configure contention-free CG communications (e.g., where resources are dedicated for the UE to transmit sidelink communications) or contention-based CG communications (e.g., where the UE contends for access to a channel in the configured resource allocation, such as by using a channel access procedure or a channel sensing procedure).

In some examples, a network node 110 may transmit CG activation DCI to the UE 120 (e.g., directly or via one or more network nodes) to activate the CG configuration for the UE 120. The network node 110 may indicate, in the CG activation DCI, communication parameters, such as an MCS, an RB allocation, and/or antenna ports, for the CG communications to be transmitted in the scheduled CG occasions 505. The UE 120 may begin transmitting in the CG occasions 505 based at least in part on receiving the CG activation DCI. For example, beginning with a next scheduled CG occasion 505 subsequent to receiving the CG activation DCI, the UE 120 may transmit a sidelink communication in the scheduled CG occasions 505 using the communication parameters indicated in the CG activation DCI. The UE 120 may refrain from transmitting in configured CG occasions 505 prior to receiving the CG activation DCI.

The network node 110 may transmit CG reactivation DCI to the UE 120 (e.g., directly or via one or more network nodes) to change the communication parameters for the CG occasions. Based at least in part on receiving the CG reactivation DCI, and the UE 120 may begin transmitting in the scheduled CG occasions 505 using the communication parameters indicated in the CG reactivation DCI. For example, beginning with a next scheduled CG occasion 505 subsequent to receiving the CG reactivation DCI, the UE may transmit sidelink communications in the scheduled CG occasions 505 based at least in part on the communication parameters indicated in the CG reactivation DCI.

In some cases, such as when the network node 110 needs to override a scheduled CG communication for a higher priority communication, the network node 110 may transmit CG cancellation DCI to the UE 120 (e.g., directly or via one or more network nodes) to temporarily cancel or deactivate one or more subsequent CG occasions 505 for the UE. The CG cancellation DCI may deactivate only a subsequent one CG occasion 505 or a subsequent N CG occasions 505 (where N is an integer). CG occasions 505 after the one or more (e.g., N) CG occasions 505 subsequent to the CG cancellation DCI may remain activated. Based at least in part on receiving the CG cancellation DCI, the UE 120 may refrain from transmitting in the one or more (e.g., N) CG occasions 505 subsequent to receiving the CG cancellation DCI. As shown in example 500, the CG cancellation DCI cancels one subsequent CG occasion 505 for the UE 120. After the CG occasion 505 (or N CG occasions) subsequent to receiving the CG cancellation DCI, the UE 120 may automatically resume transmission in the scheduled CG occasions 505.

The network node 110 may transmit CG release DCI to the UE 120 (e.g., directly or via one or more network nodes) to deactivate the CG configuration for the UE 120. The UE 120 may stop transmitting in the scheduled CG occasions 505 based at least in part on receiving the CG release DCI. For example, the UE 120 may refrain from transmitting in any scheduled CG occasions 505 until another CG activation DCI is received by the UE 120. Whereas the CG cancellation DCI may deactivate only a subsequent one CG occasion 505 or a subsequent N CG occasions 505, the CG release DCI deactivates all subsequent CG occasions 505 for a given CG configuration for the UE until the given CG configuration is activated again by a new CG activation DCI.

As indicated above, FIG. 5 is provided as an example. Other examples may differ from what is described with respect to FIG. 5.

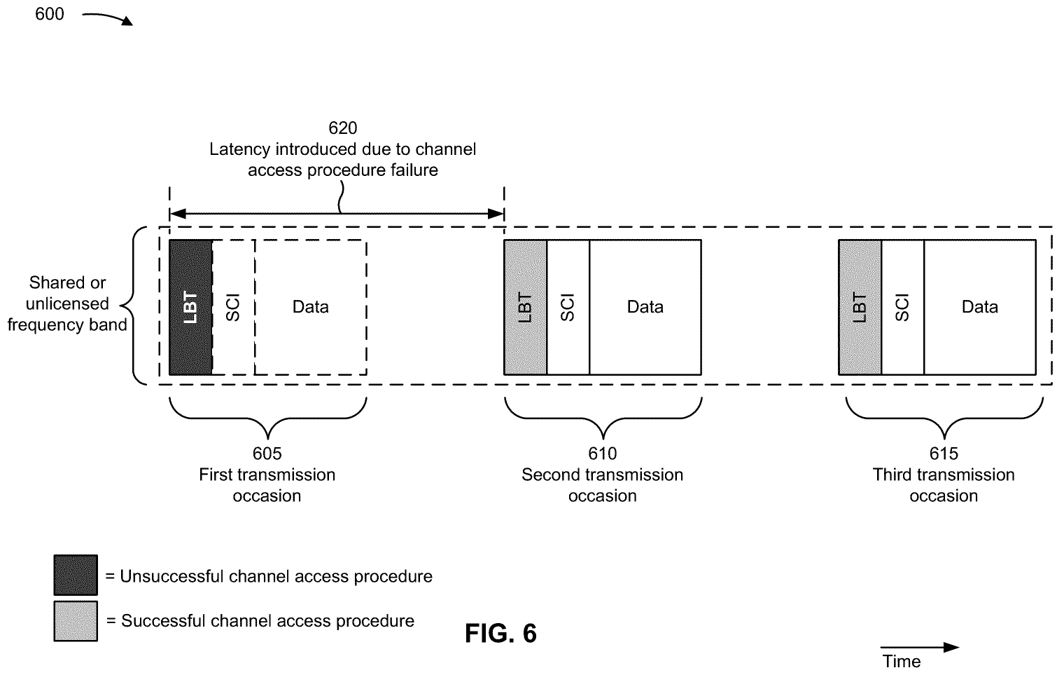

FIG. 6 is a diagram illustrating an example 600 of sidelink communication in a shared or unlicensed frequency band, in accordance with the present disclosure. Various techniques may be used to increase data rates associated with sidelink networks. For example, some wireless network may support carrier aggregation for sidelink communication. As another example, some wireless network may support sidelink communications via unlicensed frequency bands or shared frequency bands (e.g., an unlicensed or shared frequency spectrum), thereby providing additional frequency domain resources that are available to be used for sidelink communications. A shared or unlicensed frequency band may be a frequency band that is associated with non-exclusive usage associated with various operators, devices, and/or RATs, among other examples.

For example, in a shared or unlicensed frequency band, devices using different RATs may communicate using the same frequency band (e.g., the same channel). For the two different type of devices (e.g., using different RATs) to coexist while using a common carrier frequency, there is a need for a mechanism to efficiently utilize resource allocation by the two RATs without negatively impacting the operation of each RAT. For example, in a shared or unlicensed frequency band, a transmitting device may contend against other devices for channel access before transmitting on a shared or unlicensed channel to reduce and/or prevent collisions on the shared or unlicensed channel. To contend for channel access, the transmitting device may perform a channel access procedure, such as a listen-before-talk (or listen-before-transmit) (LBT) procedure or another type of channel access procedure, for shared or unlicensed frequency band channel access. The channel access procedure may be performed to determine whether the physical channel (e.g., the radio resources of the channel) are free to use or are busy (e.g., in use by another wireless communication device such as a UE, an IoT device, or a WLAN device, among other examples).

The channel access procedure may include sensing or measuring the physical channel (e.g., performing an RSRP measurement, detecting an energy level, or performing another type of measurement) during a channel access gap (which may also be referred to as a contention window (CW)) and determining whether the shared or unlicensed channel is free or busy based at least in part on the signals sensed or measured on the physical channel (e.g., based at least in part on whether the measurement satisfies a threshold). If the transmitting device determines that the channel access procedure was successful, then the transmitting device may perform one or more transmissions on the shared or unlicensed channel during a transmission opportunity, which may extend for a channel occupancy time (COT). If the transmitting device determines that the channel access procedure was unsuccessful, then the transmitting device may refrain from performing one or more transmissions on the shared or unlicensed channel.

For example, as shown in FIG. 6, a UE 120 may attempt to transmit a sidelink communication (e.g., sidelink data and/or a sidelink TB) using a first transmission occasion 605. The UE 120 may perform a channel access procedure (e.g., shown in FIG. 6 as an LBT procedure as an example) prior to transmitting the sidelink communication. As shown in FIG. 6, the channel access procedure may be unsuccessful (e.g., the shared or unlicensed frequency band may be busy). As a result, the UE 120 may refrain from transmitting the sidelink communication using the first transmission occasion 605.

As shown in FIG. 6, the UE 120 may be associated with a second transmission occasion 610 and/or a third transmission occasion 615. For example, in some cases, based at least in part on being unable to transmit the sidelink communication using the first transmission occasion 605 (e.g., due to the failed channel access procedure), the UE 120 may transmit, to a network node 110, a request for additional time-frequency resources to be used to transmit a retransmission of the sidelink communication. The network node 110 may transmit an indication of the second transmission occasion 610 and/or the third transmission occasion 615 to the UE 120 (e.g., directly or via one or more network nodes). This may consume additional radio resources and signaling overhead associated with the UE 120 transmitting a request for the additional resources and the network node 110 transmitting a grant indicating the additional resources.

As another example, the first transmission occasion 605 may be associated with a configured grant configuration. The configured grant configuration may indicate that the second transmission occasion 610 and/or the third transmission occasion 615 are transmission occasions that are available to be used for a retransmission of a sidelink communication associated with the first transmission occasion 605. Therefore, the UE 120 may use the second transmission occasion 610 and/or the third transmission occasion 615 to transmit the sidelink communication.

However, as shown by reference number 620, delaying a transmission of the sidelink communication to the second transmission occasion 610 may introduce latency associated with transmitting the sidelink communication. For example, there may be a delay associated with the UE 120 requesting additional resources (e.g., an SR communication) and the network (e.g., one or more network nodes 110) signaling granted resources (e.g., the second transmission occasion 610 and/or the third transmission occasion 615) to the UE 120. As another example, the second transmission occasion 610 may be configured to occur with a gap between the first transmission occasion 605 and the second transmission occasion 610 that is large enough (e.g., multiple slots after the first transmission occasion 605) to allow time for sidelink feedback (e.g., a PSFCH communication) to be transmitted to the UE 120.

As another example, a receiving UE may attempt to transmit HARQ feedback to a transmitting UE (e.g., via a PSFCH communication), but the feedback communication may fail, such as due to an unsuccessful channel access procedure (e.g., performed by the receiving UE) associated with the feedback communication, a failure to decode SCI1/SCI2 by the receiving UE, and/or a failure to decode the feedback communication by the transmitting UE, among other examples. A transmission via the PSSCH (e.g., a sidelink communication) for which the transmitting UE does not receive ACK feedback may result in the transmitting UE transmitting a request for resources for a dynamic retransmission (e.g., via an SR communication) and a network node 110 transmitting a grant for the resources for the dynamic retransmission (e.g., via DCI), thereby increasing signaling overhead and limiting a capacity of a network node 110 to process all retransmission scheduling.

Further, lost HARQ feedback (e.g., PSFCH communication) due to channel access procedure failures may cause a large quantity of HARQ retransmissions, thereby significantly limiting a capacity of the sidelink network. Additionally, solutions to mitigate PSFCH LBT failures introduces uncertainty at a UE 120 as to when the HARQ feedback is to be received, impacting when the HARQ feedback is to be transmitted to a network node 110 (e.g., via a PUCCH communication). Additionally, the network (e.g., one or more network nodes 110) may be unaware that the sidelink communication failures are associated with channel access procedure failures. Therefore, the network may continue to schedule a UE 120 to transmit sidelink communications via a congested or busy channel, resulting in persistent channel access procedure failures.

In other words, there is currently no mechanisms to handle channel access procedure failures (e.g., LBT failures) for sidelink communications in a shared or unlicensed frequency band. Rather, channel access procedure failures (e.g., LBT failures) are treated as conventional sidelink transmission failures. As a result, the UE 120 may have to wait for retransmission resources or signal a NACK indication to a network node, thereby introducing significant latency and/or signaling overhead associated with sidelink communications associated with a shared or unlicensed frequency band.

Some techniques and apparatuses described herein enable configured grant sidelink communications. For example, a UE (e.g., a UE 120) may perform a channel access procedure associated with a transmission of a sidelink communication that is to be associated with resources that are associated with a first configured grant configuration. If the channel access procedure is unsuccessful then the UE may change or set a state associated with a HARQ process identifier (e.g., that is associated with the sidelink communication) to pending (e.g., from not pending). The UE may transmit, based at least in part on successfully performing another channel access procedure, a retransmission of the sidelink communication using resources associated with the first configured grant configuration or a second configured grant configuration (e.g., based at least in part on the state associated with the HARQ process identifier being changed to pending). In other words, the UE may autonomously (e.g., without receiving signaling from the network) retransmit the sidelink configuration using the same configured grant configuration or a different configured grant occasion.

As a result, latency associated with transmitting the sidelink communication may be reduced. For example, the autonomous retransmissions may enable quick channel access recovery by the UE without waiting some amount of time (e.g., multiple slots) for a retransmission that may be scheduled after a feedback slot (e.g., for providing feedback associated with a configured grant occasion that is associated with a channel access failure) that does not carry useful information (e.g., because no transmission occurred during the configured grant occasion). Enabling attempted transmissions of a sidelink communication associated with a HARQ process identifier using different configured grant configurations or occasions (e.g., enabling HARQ sharing for sidelink communications in a shared or unlicensed frequency band) may enable the UE to quickly recover from a channel access failure and to reduce latency associated with transmitting a sidelink communication.

In some aspects, a CG timer may be used by the UE. The CG timer may be maintained by the UE per HARQ process identifier. The CG timer may be associated with an amount of time that the UE is to keep data associated with the sidelink communication stored in a HARQ buffer. For example, the CG timer may bound an amount of time that a TB is expected to stay in the HARQ buffer. This may ensure that the UE does not continue to attempt to transmit the same sidelink communication (e.g., the same TB) indefinitely. In some aspects, a retransmission timer may be used by the UE. The retransmission timer may be maintained by the UE per configured grant configuration. The retransmission timer may be associated with an amount of time after which the UE is to automatically transmit another retransmission of the sidelink communication. For example, the retransmission timer may enable the UE to remove uncertainty as to when the UE is to perform a retransmission of a sidelink communication (e.g., uncertainty that may be introduced due to a receiving UE failing to decode SCI, or the receiving UE experiencing a channel access failure when attempting to transmit feedback to the UE, among other examples).

As indicated above, FIG. 6 is provided as an example. Other examples may differ from what is described with respect to FIG. 6.

FIGS. 7A and 7B are diagrams of an example 700 associated with configured grant sidelink communications in a shared or unlicensed frequency band, in accordance with the present disclosure. As shown in FIGS. 7A and 7B, one or more network nodes (e.g., a network node 110, a CU, a DU, and/or an RU) may communicate with a first UE 705 (e.g., a UE 120) and/or a second UE 710 (e.g., a UE 120). In some aspects, the network node 110, the first UE 705, and the second UE 710 may be part of a wireless network (e.g., the wireless network 100). In some aspects, the first UE 705 and the network node 110 and/or the second UE 710 and the network node 110 may have established a wireless connection prior to operations shown in FIGS. 7A and 7B.

In some aspects, the first UE 705 and the second UE 710 may have established a wireless connection prior to operations shown in FIGS. 7A and 7B (e.g., via a sidelink channel or a PC5 interface, in a similar manner as described in connection with FIGS. 3 and 4). The first UE 705 and the second UE 710 may communicate via a sidelink or a PC5 interface (e.g., in a similar manner as described in connection with FIGS. 3 and 4). In some aspects, the first UE 705 and the second UE 710 may communicate using a Mode 1 operating mode (e.g., where resource selection and/or scheduling is performed by the network node 110). In some aspects, the first UE 705 and the second UE 710 may communicate via an unlicensed or shared sidelink frequency band (e.g., sometimes referred to as a sidelink unlicensed (SL-U) frequency band). For example, the first UE 705 and the second UE 710 may communicate via one or more SL-U procedures (e.g., as defined, or otherwise fixed, by a wireless communication standard, such as the 3GPP).

As used herein, the network node 110 “transmitting” a communication to a UE (e.g., the first UE 705 or the second UE 710) may refer to a direct transmission (for example, from the network node 110 to the UE) or a transmission via one or more other network nodes or devices. For example, if the network node 110 is a DU, an indirect transmission to the UE may include the DU transmitting a communication to an RU and the RU transmitting the communication to the UE 120. Similarly, a UE (e.g., the first UE 705 or the second UE 710) “transmitting” a communication to the network node 110 may refer to a direct transmission (for example, from the UE to the network node 110) or a transmission via one or more other network nodes or devices. For example, if the network node 110 is a DU, an indirect transmission to the network node 110 may include the UE 120 transmitting a communication to an RU and the RU transmitting the communication to the DU.

In some aspects, as shown by reference number 715, the network node 110 may transmit, and the first UE 705 and/or the second UE 710 may receive, configuration information. In some aspects, the first UE 705 and/or the second UE 710 may receive the configuration information via one or more of RRC signaling, one or more medium access control (MAC) control elements (MAC-CEs), and/or DCI, among other examples. In some aspects, the configuration information may include an indication of one or more configuration parameters for selection by the first UE 705 and/or the second UE 710, and/or explicit configuration information for the first UE 705 and/or the second UE 710 to use to configure itself, among other examples. The first UE 705 and/or the second UE 710 may receive the configuration information via a Uu interface.

In some aspects, the configuration information may be associated with a sidelink configuration. For example, the first UE 705 and/or the second UE 710 may be configured to perform one or more operations described herein associated with a sidelink or PC5 interface. In some aspects, the configuration information may be, or may be associated with, an SL-U configuration. For example, the first UE 705 and/or the second UE 710 may be configured to perform one or more operations described herein via a shared or unlicensed frequency band.

In some aspects, the configuration information may be associated with one or more configured grant configurations. For example, a configured grant configuration may indicate one or more time-frequency resources associated with a configured grant occasion (e.g., for initial transmissions of a sidelink communication) and a periodicity associated with the configured grant occasion. Additionally, the configured grant configuration may indicate time-frequency resources associated with one or more configured grant occasions that are associated with retransmissions of an initial transmission that is associated with the configured grant occasion. “Retransmission” may refer to a subsequent transmission of information following an initial transmission (or an attempted initial transmission) of the information. For example, an initial transmission and a retransmission may be associated identical information or data (e.g., the same TB). The configuration information may indicate multiple configured grant configurations that are associated with the shared or unlicensed frequency band to be used by the first UE 705 and/or the second UE 710. For example, the first UE 705 may be configured with configured grant occasions associated with different configured grant configurations that can be used by the first UE 705 for sidelink communications. In some aspects, each configured grant configuration may be associated with respective identifiers or index values.

The configured grant configuration(s) may be type 1 configured grant configurations or type 2 configured grant configuration. In a Type 1 configured grant configuration, a UE (e.g., the first UE 705 and/or the second UE 710) can perform sidelink data transmission without a grant based at least in part on an RRC (re)configuration without any Layer 1 (L1) signaling, and in a Type 2 configured grant configuration, the UE can perform uplink data transmission without a grant based at least in part on an RRC (re)configuration in combination with L1 signaling (e.g., downlink control information) to activate and/or release the Type 2 CG configuration.

In some aspects, the configuration information may indicate that HARQ process sharing is enabled for the shared or unlicensed frequency band to be used by the first UE 705 and/or the second UE 710. For example, the configuration information may indicate that the first UE 705 and/or the second UE 710 may attempt a transmission of a sidelink communication associated with a given HARQ process identifier via configured grant occasions that are associated with different configured grant configurations, as explained in more detail elsewhere herein.

In some aspects, the configuration information may indicate configurations of one or more timers associated with the configured grant configuration(s). For example, the configuration information may indicate information associated with one or more timers associated with the HARQ process sharing. The one or more timers may include a CG timer and/or a retransmission timer, among other examples. As described in more detail elsewhere herein, a CG timer may be associated with an amount of time that a UE (e.g., the first UE 705 and/or the second UE 710) is to keep data associated with a given sidelink communication and/or a given HARQ process identifier stored in a HARQ buffer. The configuration information may indicate that the CG timer is to be associated with a given HARQ process identifier (e.g., is to be maintained per HARQ process identifier). The retransmission timer may be associated with an amount of time after which the UE is to automatically transmit another retransmission of a sidelink communication (e.g., via the same configured grant configuration or a different configured grant configuration). The configuration information may indicate that the retransmission timer is to be associated with a given configured grant configuration (e.g., the retransmission timer may be maintained by a UE per configured grant configuration).

For example, the configuration information may indicate that the one or more timers are enabled or configured for the first UE 705 and/or the second UE 710. In some aspects, the configuration information may indicate an amount of time to be associated with at least one (or all) of the one or more timers. For example, the configuration information may indicate an amount of time associated with the CG timer and/or an amount of time associated with the retransmission timer.

The first UE 705 may configure itself based at least in part on the configuration information. In some aspects, the second UE 710 may configure itself based at least in part on the configuration information. In some aspects, the first UE 705 and/or the second UE 710 may be configured to perform one or more operations described herein based at least in part on the configuration information.

In some aspects, the first UE 705 may attempt to transmit a sidelink communication (e.g., a TB). For example, sidelink data may arrive at the first UE 705. Additionally, the first UE 705 may detect that there is an upcoming configured grant occasion (e.g., that is associated with a first configured grant configuration). In some aspects, the first UE 705 may determine whether the configured grant occasion is associated with a first resource for the first configured grant configuration. In other words, the first UE 705 may determine whether the configured grant occasion is associated with an initial transmission or a retransmission. If the configured grant occasion is associated with a retransmission, then the first UE 705 may determine whether a CG timer associated with data that is to be retransmitted via the configured grant occasion (e.g., data that was previously transmitted by the first UE 705 using a previous configured grant occasion associated with the first configured grant configuration) has expired or is running. If the CG timer is expired or is not running, then the first UE 705 may ignore the configured grant occasion (e.g., may refrain from transmitting a sidelink communication using the configured grant occasion). If the CG timer is running and/or is not expired, then the first UE 705 may proceed with attempting to transmit a retransmission of the data using the configured grant occasion.

In some aspects, the first UE 705 may determine or select a HARQ process identifier to be associated with the configured grant occasion (e.g., a HARQ process identifier to be carried on the configured grant occasion). The first UE 705 may identify a state associated with the HARQ process identifier. For example, the state may be “pending” (e.g., indicating that data associated with the HARQ process identifier is pending transmission) or “not pending” (e.g., indicating that data associated with the HARQ process identifier is not pending transmission or has been transmitted at least once), among other examples. A “pending” state (e.g., indicating that data associated with the HARQ process identifier is pending transmission) may also be referred to as a “first state” herein. A “not pending” (e.g., indicating that data associated with the HARQ process identifier is not pending transmission or has been transmitted at least once) may also be referred to as a second state herein. If the state of the HARQ process identifier is not pending, then the first UE 705 may determine whether a CG timer associated with the HARQ process identifier is running and/or not expired. If the CG timer is running and/or not expired, then the first UE 705 may proceed with attempting a transmission (or retransmission) of the sidelink communication or data associated with the HARQ process identifier. If the CG timer is not running and/or is expired, then the first UE 705 may refrain from attempting a transmission of the sidelink communication or data associated with the HARQ process identifier (e.g., and may perform one or more actions as described in more detail elsewhere herein).

Additionally, if the state of the HARQ process identifier is not pending, then the first UE 705 may determine whether a retransmission timer associated with the first configured grant occasion is configured and/or is running. If the retransmission timer is configured and is running or not expired, then the first UE 705 may refrain from attempting a transmission of the sidelink communication or data associated with the HARQ process identifier (e.g., until after the retransmission timer expires). If the retransmission timer is configured and is not running or is expired, then the first UE 705 may proceed with attempting a transmission (or retransmission) of the sidelink communication or data associated with the HARQ process identifier.

If the state of the HARQ process identifier is pending, then the first UE 705 may proceed with attempting a transmission of the sidelink communication or data associated with the HARQ process identifier. For example, the first UE 705 may provide sidelink data or a TB associated with the sidelink communication and HARQ information associated with the HARQ process identifier to a HARQ entity associated with the first UE 705 (e.g., to perform a transmission of the sidelink communication). If the state associated with the HARQ process identifier is pending, then the first UE 705 may change the state associated with the HARQ process identifier to not pending based at least in part on providing the information to the HARQ entity. To change a state may refer to the first UE 705 setting a state or a value associated with the HARQ process identifier to different state or value than currently set.

As shown by reference number 720, attempting a transmission (or retransmission) of the sidelink communication may include performing a channel access procedure associated with the transmission of the sidelink communication that is to be associated with resources that are associated with the configured grant occasion (e.g., that is associated with the first configured grant configuration). For example, a channel access procedure may be associated with a transmission of the sidelink communication where the channel access procedure is performed to contend for access to a channel (e.g., an unlicensed or shared channel) for the transmission of the sidelink communication. The transmission of the sidelink communication may be associated with resources where the resources are time-frequency resources (e.g., radio resources) to be used to transmit the sidelink communication. The resources may be associated with a configured grant occasion where a configuration (or other indication) that indicates information associated with the configured grant occasion includes an indication of the resources.

As described elsewhere herein, the channel access procedure may include an LBT procedure or another channel access procedure. For example, the first UE 705 may perform one or more measurements associated with the sidelink channel (e.g., associated with the shared or unlicensed frequency band used by the first UE 705). The first UE 705 may determine whether a transmission can be performed using the resources associated with the configured grant occasion based at least in part on the one or more measurements. For example, if values associated with the one or more measurements satisfy a threshold, then the first UE 705 may not proceed with performing the transmission (e.g., the channel access procedure may be unsuccessful because the one or more measurements indicate that the sidelink channel is busy or congested). If the values associated with the one or more measurements do not satisfy the threshold, then the first UE 705 may proceed with performing the transmission (e.g., the channel access procedure may be successful because the one or more measurements indicate that the sidelink channel is not busy).

Based at least in part on initiating an attempt to transmit the sidelink communication (e.g., based at least in part on performing the channel access procedure), the first UE 705 may initiate one or more timers. For example, the first UE 705 may initiate a CG timer associated with the HARQ process identifier. Additionally, or alternatively, the first UE 705 may initiate a retransmission timer associated with the first configured grant configuration. Alternatively, the first UE 705 may initiate the one or more timers based at least in part on the channel access procedure being successful (e.g., if the channel access procedure is not successful, then the first UE 705 may not initiate the one or more timers).

As shown by reference number 725, the first UE 705 may detect a channel access failure associated with the attempted transmission of the sidelink communication. For example, the first UE 705 may detect that the channel access procedure (e.g., performed by the first UE 705 as described above in connection with reference number 720) is unsuccessful. The first UE 705 may perform one or more actions based at least in part on detecting that the channel access procedure is unsuccessful. For example, the first UE 705 may stop one or more timers that are running associated with the HARQ process identifier and/or the first configured grant configuration. For example, if a CG timer associated with the HARQ process identifier is running, then the first UE 705 may stop the CG timer based at least in part on detecting that the channel access procedure is unsuccessful. As another example, if a retransmission timer associated with the first configured grant configuration is running, then the first UE 705 may stop the retransmission timer based at least in part on detecting that the channel access procedure is unsuccessful. For example, a timer associated with the HARQ process identifier and/or the first configured grant occasion may have been initiated and is not expired when the channel access procedure associated with the transmission of the sidelink communication is performed, and the timer may be stopped (e.g., by the first UE 705) based at least in part on the channel access procedure being unsuccessful.

As another example, as shown by reference number 730, the first UE 705 may modify the state of the HARQ process identifier based at least in part on detecting that the channel access procedure is unsuccessful. For example, the first UE 705 may change the state of the HARQ process identifier to pending (e.g., from not pending) based at least in part on the channel access procedure being unsuccessful. Modifying the state of the HARQ process identifier may enable the first UE 705 to quickly recover from the channel access failure. For example, if the state of the HARQ process identifier were to remain as not pending after the channel access procedure is unsuccessful, then the first UE 705 may have to wait until a next configured grant occasion associated with the first configured grant configuration to attempt a retransmission of the sidelink communication. Based at least in part on modifying the state of the HARQ process identifier to pending after the channel access procedure is unsuccessful, the first UE 705 may be enabled to attempt a retransmission of the sidelink communication using a configured grant occasion (e.g., associated with a second configured grant configuration) that may occur earlier in time than the next configured grant occasion associated with the first configured grant configuration, thereby reducing latency associated with the sidelink communication.

In some aspects, a rule (e.g., defined, or otherwise fixed, by a wireless communication standard, such as the 3GPP) may define that configured grant occasions that are associated with retransmissions may only be used by a UE to transmit the same data or TB that was attempted to be transmitted in a configured grant occasion associated with initial transmissions. However, in cases where HARQ sharing is enabled, this may result in configured grant occasions that are associated with retransmissions being unused when a UE experiences a channel access procedure failure. For example, the first UE 705 may be use retransmission configured grant occasions associated with the first configured grant occasion only for transmissions associated with the sidelink communication (e.g., that was attempted to be transmitted as described above in connection with reference number 720). However, because the first UE 705 may transmit the sidelink communication using another configured grant occasion (e.g., as described in more detail elsewhere herein), the retransmission configured grant occasions associated with the first configured grant occasion may be reserved for the sidelink communication, but may not be needed by the first UE 705, thereby degrading resource utilization by the first UE 705.

To address this problem, in some aspects, the attempted transmission is not counted for the first configured grant configuration. For example, the rule (e.g., defined, or otherwise fixed, by a wireless communication standard, such as the 3GPP) may be relaxed to not count channel access procedure failures (e.g., LBT failures) as attempted transmissions. Therefore, the resources associated with the retransmission configured grant occasions may be used for another purpose or another transmission by the first UE 705. As another example, a logical channel priority associated with the first configured grant configuration may be modified based at least in part on the channel access procedure being unsuccessful. For example, a configured grant resource carrying no TB (e.g., the retransmission configured grant occasions) may have a lowest logical channel priority among all transmissions associated with the first UE 705. In this way, the first UE 705 may apply one or more priority rules to transmit other higher priority transmissions using the resources associated with the retransmission configured grant occasions.

In some aspects, the first UE 705 may transmit, and the network node 110 may receive, an indication that the first configured grant configuration is not used for the sidelink communication or the HARQ process identifier (e.g., based at least in part on the channel access procedure being unsuccessful). The indication may be included in Layer 1 signaling or Layer 2 signaling, among other examples. For example, the indication may be included in a PUSCH communication, a MAC-CE communication, or another type of communication. The indication may be an unused resource indication indicating to the network node 110 that the first UE 705 may not use additional resources (e.g., retransmission resources) associated with the first configured grant configuration (e.g., because the UE utilizes autonomous retransmissions as described in more detail elsewhere herein). The indication may include an indication that the first configured grant configuration is not used (e.g., an “unused indication”), and/or an identifier (e.g., a CG index) associated with the first configured grant configuration, among other examples. Based at least in part receiving the indication that the first configured grant configuration is not used for the sidelink communication or the HARQ process identifier, the network node 110 may re-allocate the additional resources (e.g., retransmission resources) associated with the first configured grant configuration that would have otherwise been unused by the first UE 705. For example, the network node 110 may indicate a different communication to be transmitted by the first UE 705 using the additional resources (e.g., retransmission resources) associated with the first configured grant configuration. As another example, the network node 110 may allocate the additional resources (e.g., retransmission resources) associated with the first configured grant configuration to a different UE. This may improve a resource utilization associated with the sidelink network and/or the shared or unlicensed frequency band.

In some aspects, as shown by reference number 735, the first UE 705 may transmit, and the network node 110 may receive, an indication of the channel access procedure failure. For example, the first UE 705 may transmit the indication based at least in part on a quantity of channel access procedures that are unsuccessful, including the channel access procedure (e.g., performed by the first UE 705 as described in connection with reference number 720), satisfying a threshold. For example, the first UE 705 may transmit, and the network node 110 may receive, an indication of persistent channel access failures. This may enable the network node 110 to distinguish between transmission or reception failures that are associated with poor channel conditions or poor radio conditions (e.g., that may be associated with NACK feedback) and transmission or reception failures that are associated with an occupied or congested frequency band (e.g., that may be associated with unsuccessful channel access procedures). This may enable the network node 110 (or another network node) to make improved scheduling and/or configuration determinations for the first UE 705. For example, transmission or reception failures that are associated with an occupied or congested frequency band may not be resolved by scheduling retransmissions or by modifying transmission parameters, such as a transmission power, a beam, and/or other transmission parameters because the first UE 705 may still be unable to access the channel due to persistent channel access procedure failures. By enabling the network node 110 to distinguish between transmission or reception failures that are associated with an occupied or congested frequency band and transmission or reception failures that are associated with poor channel conditions, a performance of the first UE 705 may be improved (e.g., because the network node 110 may be enabled to better address the issues causing the transmission or reception failures).

In some aspects, a physical (PHY) layer entity of the first UE 705 may provide information associated with channel access procedures to a MAC entity of the first UE 705. The MAC entity may maintain information associated with channel access procedures performed by the first UE 705 and/or the PHY layer entity. For example, the MAC entity may maintain information associated with channel access procedures performed by the first UE 705 associated with a given bandwidth or bandwidth part (e.g., irrespective of an intended receiver of sidelink communications).

In some aspects, the configuration information may indicate one or more parameters associated with persistent channel access failures for sidelink. For example, the configuration information (e.g., an RRC configuration) may indicate information associated with a failure detection timer (e.g., an SL-lbt-FailureDetectionTimer) and/or a threshold associated with reporting a persistent channel access failure (e.g., an SL-lbt-FailureInstanceMaxCount parameter), among other examples. The failure detection timer (e.g., the SL-lbt-FailureDetectionTimer) may be restarted by the first UE 705 and/or the MAC entity each time the first UE 705 detects a channel access procedure failure. The threshold associated with reporting a persistent channel access failure may indicate a quantity of channel access procedure failures (e.g., that, if exceeded, should be reported by the first UE 705 to the network node 110). For example, a counter may be maintained by the first UE 705 and/or the MAC entity. Each time a channel access procedure failure is detected (e.g., associated with a given bandwidth or bandwidth part), the counter may be incremented. If the failure detection timer (e.g., the SL-lbt-FailureDetection Timer) expires, then the counter may be reset. If a value of the counter exceeds the threshold associated with reporting a persistent channel access failure (e.g., an SL-lbt-FailureInstanceMaxCount parameter), then the first UE 705 may transmit the indication of persistent channel access failures. For example, the indication may be included in a MAC-CE communication.

If there are no resources available for the first UE 705 to transmit the indication of persistent channel access failures, then the first UE 705 may transmit, and the network node 110 may receive, an SR requesting resources for the transmission. The network node 110 may transmit, and the first UE 705 may receive, information indicating resources available for the first UE 705 to use to transmit the indication of persistent channel access failures.

In some aspects, based at least in part on receiving the indication of persistent channel access failures, the network node 110 may perform one or more actions. For example, the network node 110 may modify or change a bandwidth, a bandwidth part, or a frequency band, among other examples, used by the first UE 705 for sidelink communications. For example, the network node 110 may transmit an RRC reconfiguration intended for the first UE 705 to modify frequency domain resources used by the first UE 705 for sidelink communications. For example, based at least in part on identifying that communication failures associated with the first UE 705 are due to an occupied or congested frequency band or channel, the network node 110 may modify or change a bandwidth, a bandwidth part, or a frequency band, among other examples, used by the first UE 705 to enable the first UE 705 to use a different frequency band or channel. This may improve a likelihood that the first UE 705 may be enabled to successfully perform a channel access procedure and successfully transmit one or more sidelink communications.

As shown by reference number 740, the first UE 705 may select a new configured grant occasion for the sidelink communication and/or the HARQ process identifier (e.g., that was attempted to be transmitted as described above in connection with reference number 720 and/or 725). For example, based at least in part on changing the state of the HARQ process identifier to pending, the sidelink communication and/or the HARQ process identifier may be available to be selected by the UE 120 for transmission in an upcoming configured grant occasion (e.g., rather than being confined to being transmitted only in configured grant occasions associated with the first configured grant configuration). For example, the new configured grant occasion may be associated with a second configured grant configuration. Alternatively, the new configured grant occasion may be associated with the first configured grant configuration (e.g., if the next available configured grant occasion is associated with the first configured grant configuration). For example, the first UE 705 may detect an upcoming configured grant occasion. The first UE 705 may select the HARQ process identifier to be associated with the upcoming configured grant occasion (e.g., based at least in part on the state of the HARQ process identifier being “pending” and/or based at least in part on one or more priority rules).

As shown by reference number 745, the first UE 705 may perform a channel access procedure (e.g., an LBT procedure or another procedure) associated with attempting to transmit (or retransmit) the sidelink communication (e.g., a retransmission of the sidelink communication) using the selected configured grant occasion. For example, the first UE 705 may perform the channel access procedure 745 based at least in part on the HARQ process identifier being set to “pending” and/or based at least in part on a previous channel access procedure (e.g., as shown at reference number 720) being unsuccessful. The first UE 705 may perform the channel access procedure in a similar manner as described in more detail elsewhere herein. The first UE 705 may determine that the channel access procedure is successful. As a result, as shown by reference number 750, the first UE 705 may transmit, and the second UE 710 may receive, the sidelink communication (or a retransmission of the sidelink communication) using resources associated with the configured grant occasion (e.g., that is associated with the first configured grant configuration or a second configured grant configuration). For example, because the state associated with the HARQ process identifier is changed to pending, the HARQ process identifier may be made available for selection (e.g., by the first UE 705) to be transmitted by the first UE 705 via the configured grant occasion. The state associated with the HARQ process identifier may be changed (e.g., by the first UE 705) to “not pending” (e.g., from pending) based at least in part on transmitting the retransmission of the sidelink communication (e.g., based at least in part on successfully performing a channel access procedure associated with transmitting the sidelink communication).

If the channel access procedure 745 is not successful, then the first UE 705 may refrain from transmitting the sidelink communication (or a retransmission of the sidelink communication). In such examples, the first UE 705 may maintain the HARQ process identifier as “pending” (e.g., not change the state associated with the HARQ process identifier to “not pending”). If a timer associated with the HARQ process identifier and/or the configured grant occasion has been initiated and is not expired when the channel access procedure 745 is performed, then the timer may be stopped (e.g., by the first UE 705) based at least in part on the channel access procedure 745 being unsuccessful.

Continuing the process described above (e.g., FIG. 7B is a continuation of FIG. 7A), as shown in FIG. 7B, and by reference number 755, the first UE 705 may initiate one or more timers based at least in part on performing the (re)transmission of the sidelink communication. For example, the first UE 705 may initiate a timer (e.g., a configured grant timer) associated with the HARQ process identifier and/or the sidelink communication based at least in part on performing the (re)transmission of the sidelink communication. The CG timer may be an SL-U CG timer. As described elsewhere herein, the CG timer may be associated with an amount of time that the first UE 705 is to keep data associated with the sidelink communication stored in a HARQ buffer. For example, the CG timer may indicate, to the MAC entity associated with the first UE 705, how long a protocol data unit (PDU) or TB associated with the sidelink communication is to be stored in HARQ buffer (e.g., if the CG timer is running, this may indicate to the MAC entity to not replace the content of the HARQ buffer, expect for prioritization purposes in some cases).

In some aspects, an amount of time associated with the CG timer (e.g., as indicated by the configuration information) may be based at least in part on a periodicity associated with the first configured grant configuration or another configured grant configuration. In some aspects, a duration or amount of time (e.g., a minimum duration or minimum amount of time that can be configured for the CG timer) associated with the CG timer may be chosen (e.g., by the network node 110 or another network node) relative to a sl-MinTimeGapPSFCH parameter and/or an sl-PSFCH-Period parameter that represent a minimum quantity of slots within the resource pool between a slot with a PSSCH transmission and the slot containing PSFCH for HARQ feedback. For example, the amount of time associated with the CG timer may be the periodicity of the first configured grant configuration modified by an integer that is equal to or greater than one (1) (e.g., 2*CG periodicity). For example, configuring the amount of time associated with the CG timer to be less than an amount of time associated with the periodicity of the configured grant occasion may result in wasted resources because some resources associated with the configured grant occasion may never be used by the first UE 705 due to the expiration of the CG timer prior to an end of a period associated with the configured grant configuration.

In some aspects, the CG timer may be stopped by the first UE 705 (e.g., prior to an expiration of the CG timer) based at least in part on one or more conditions. For example, the one or more conditions may include the first UE 705 experiencing a channel access procedure failure associated with the HARQ process identifier and/or the sidelink communication. Accordingly, the CG timer associated with the HARQ process identifier may have been initiated and may not expired when the channel access procedure associated with the transmission of the sidelink communication is performed, and the timer may be stopped (e.g., by the first UE 705) based at least in part on the channel access procedure being unsuccessful. In other words, if the first UE 705 detects a channel access procedure failure (e.g., an LBT failure) associated with the HARQ process identifier and/or the sidelink communication, then the first UE 705 may stop the CG timer that is associated with the HARQ process identifier and/or the sidelink communication.

As another example, the one or more conditions may include the first UE 705 receiving ACK feedback (e.g., on a PSFCH) associated with the HARQ identifier that is associated with the CG timer. For example, the first UE 705 may receive, from the second UE 710, a sidelink feedback communication (e.g., a PSFCH communication) indicating that the sidelink communication that is associated with the HARQ process identifier has been successfully received (e.g., ACK feedback). The first UE 705 may stop the CG timer based at least in part on receiving the sidelink feedback communication. In other words, if the first UE 705 receives ACK feedback from the second UE 710 associated with the HARQ process identifier, then the first UE 705 may stop the CG timer that is associated with the HARQ process identifier and/or the sidelink communication. In some aspects, if the sidelink feedback communication (e.g., the PSFCH communication) indicates that the sidelink communication that is associated with the HARQ process identifier has not been successfully received (e.g., NACK feedback), then the first UE 705 may not stop the CG timer.

As another example, the one or more conditions may include the first UE 705 receiving, from the network node 110, an indication of time-frequency resources to be used for a transmission or retransmission of data associated with the HARQ process identifier. For example, the first UE 705 may receive, from the network node 110, a downlink communication indicating a sidelink grant associated with at least one of the sidelink communication or the HARQ process identifier. For example, the first UE 705 may receive a PDCCH grant associated with a sidelink configured scheduling (SLCS) radio network temporary identifier (RNTI) (SLCS-RNTI) that is associated with the HARQ process identifier. The first UE 705 may stop the CG timer based at least in part on receiving the indication of the time-frequency resources to be used for a transmission or retransmission of data associated with the HARQ process identifier. In other words, if the first UE 705 receives a grant (e.g., via a PDCCH communication) associated with the HARQ process identifier (e.g., associated with the SLCS-RNTI that is associated with the HARQ process identifier), then the first UE 705 stop the CG timer that is associated with the HARQ process identifier and/or the sidelink communication.

As another example, the one or more timers may include a retransmission timer associated with at least one of the HARQ process identifier or the sidelink communication. For example, the first UE 705 may initiate the retransmission timer based at least in part on performing the (re)transmission of the sidelink communication (e.g., as described above in connection with reference number 750). The retransmission timer may be an SL-U CG retransmission timer. The retransmission timer may be associated with an amount of time after which the first UE 705 is to automatically transmit another retransmission of the sidelink communication. For example, the retransmission timer may serve as an implicit indication that the sidelink communication has not been successfully received by the second UE 710 or another UE (e.g., may serve as an implicit NACK indication). The first UE 705 may autonomously (e.g., without receiving an indication from the network node 110 and/or using a different configured grant configuration that was previously used to transmit the sidelink communication) retransmit the sidelink communication based at least in part on the retransmission timer expiring.

The retransmission timer may remove ambiguity as to when the first UE 705 is to retransmit the sidelink communication (e.g., without waiting for a next configured grant occasion associated with the configured grant configuration that was used to initially transmit the sidelink communication). For example, the second UE 710 may fail to decode SCI associated with the sidelink communication, may experience a channel access procedure failure (e.g., an LBT failure) when attempting to transmit feedback (e.g., PSFCH feedback) associated with the sidelink communication, and/or may otherwise not transmit feedback to the first UE 705 associated with the sidelink communication. The retransmission timer may enable the first UE 705 to identify a timing of a retransmission of the sidelink communication, thereby removing ambiguity associated with retransmitting configured grant sidelink communications in a shared or unlicensed frequency band.

As described elsewhere herein, the retransmission timer may be associated with (e.g., may be maintained for) a given configured grant configuration or occasion. For example, the first UE 705 may associate the retransmission timer with the configured grant configuration and/or the configured grant occasion that was used to transmit the sidelink communication (e.g., as described above in connection with reference number 750). In other words, the retransmission timer may be associated with a configured grant configuration, from the first configured grant configuration or the second configured grant configuration, that is associated with the (re)transmission of the sidelink communication.

For example, the first UE 705 may detect an expiration of the retransmission timer. The first UE 705 may select a configured grant occasion (e.g., associated with the first configured grant configuration, the second configured grant configuration, or a third configured grant configuration) to be associated with another retransmission of the sidelink communication based at least in part on the expiration of the retransmission timer. As shown by reference number 760, the first UE 705 may perform a channel access procedure associated with attempting a retransmission of the sidelink communication. The first UE 705 may perform the channel access procedure in a similar manner as described in more detail elsewhere herein.

In some aspects, the first UE 705 may determine whether a CG timer associated with the HARQ process identifier to be associated with a configured grant occasion is running. If the CG timer is not running, then the first UE 705 may interpret the HARQ process as being associated with new data (e.g., may interpret an NDI associated with the HARQ process to be toggled a value indicating new data). If the CG timer is running, then the first UE 705 may determine where a retransmission timer is configured and/or running. If the retransmission timer is configured and not running and the state of the HARQ process identifier is “not pending,” then the first UE 705 may proceed with performing a re(transmission) of the sidelink communication associated with the HARQ process identifier. If the retransmission timer is configured and is running, then the first UE 705 may refrain from performing a re(transmission) of the sidelink communication associated with the HARQ process identifier.

In some aspects, the retransmission timer may be stopped based at least in part on a CG timer being stopped. In some aspects, the first UE 705 may receive a downlink communication (e.g., from the network node 110) scheduling a retransmission (e.g., using a dynamic grant) associated with the sidelink communication. For example, the first UE 705 may receive DCI (e.g., using a DCI format 3_0) that is associated with a configured scheduling RNTI (CS-RNTI) (e.g., that is scrambled by a CS-RNTI). The first UE 705 may interpret the NDI to be not toggled. The first UE 705 may stop the CG timer and the retransmission timer (e.g., if running). The first UE 705 may proceed with performing the retransmission using the dynamic grant indicated by the network node 110.

In some aspects, the first UE 705 may stop the CG timer and/or the retransmission timer based at least in part on receiving instructions (e.g., from the network node 110) to remove content from the HARQ buffer associated with the first UE 705. For example, the first UE 705 may receive DCI (e.g., using a DCI format 3_0) that is associated with a cell RNTI (C-RNTI) indicating new data associated with the HARQ process identifier. The first UE 705 may identify that a previous grant associated with the HARQ process identifier was associated with a CS-RNTI or a configured grant. Therefore, the first UE 705 may stop the CG timer and/or the retransmission timer and may proceed with performing a transmission as instructed by the DCI.

As shown by reference number 765, the first UE 705 may transmit (e.g., autonomously) a retransmission of the sidelink communication using resources associated with the selected configured grant occasion (e.g., associated with the first configured grant configuration, the second configured grant configuration, or a third configured grant configuration) based at least in part on the retransmission timer expiring. For example, the first UE 705 may transmit the retransmission of the sidelink communication based at least in part on the channel access procedure (e.g., performed by the first UE 705 as described in connection with reference number 760) being successful. For example, if the channel access procedure (e.g., performed by the first UE 705 as described in connection with reference number 760) is unsuccessful, then the first UE 705 may refrain from transmitting the retransmission and may perform one or more other actions described herein associated with channel access procedure failures, such as stopping the CG timer and/or changing the state of the HARQ process identifier to pending, among other examples.

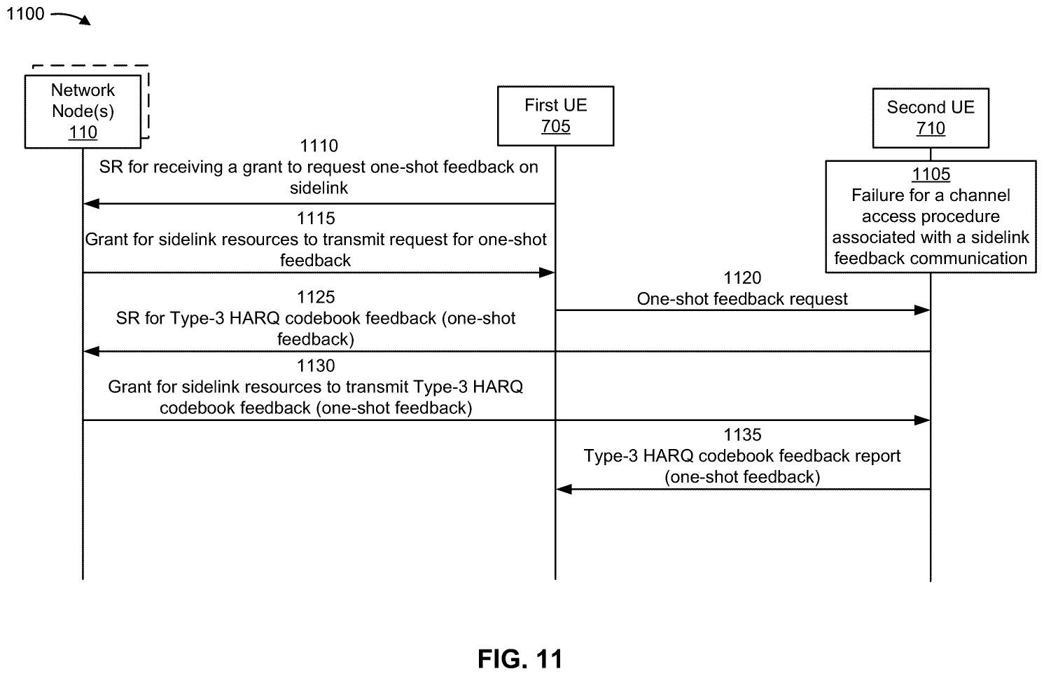

In some aspects, the second UE 710 may transmit sidelink feedback (e.g., a PSFCH communication) associated with the sidelink communication (e.g., associated with the HARQ process identifier and/or the TB). In some examples, the second UE 710 may utilize one-shot feedback (e.g., a Type-3 HARQ codebook report) to transmit the sidelink feedback to mitigate issues introduced due to persistent channel access procedure failures, as depicted and described in more detail in connection with FIGS. 11-13.

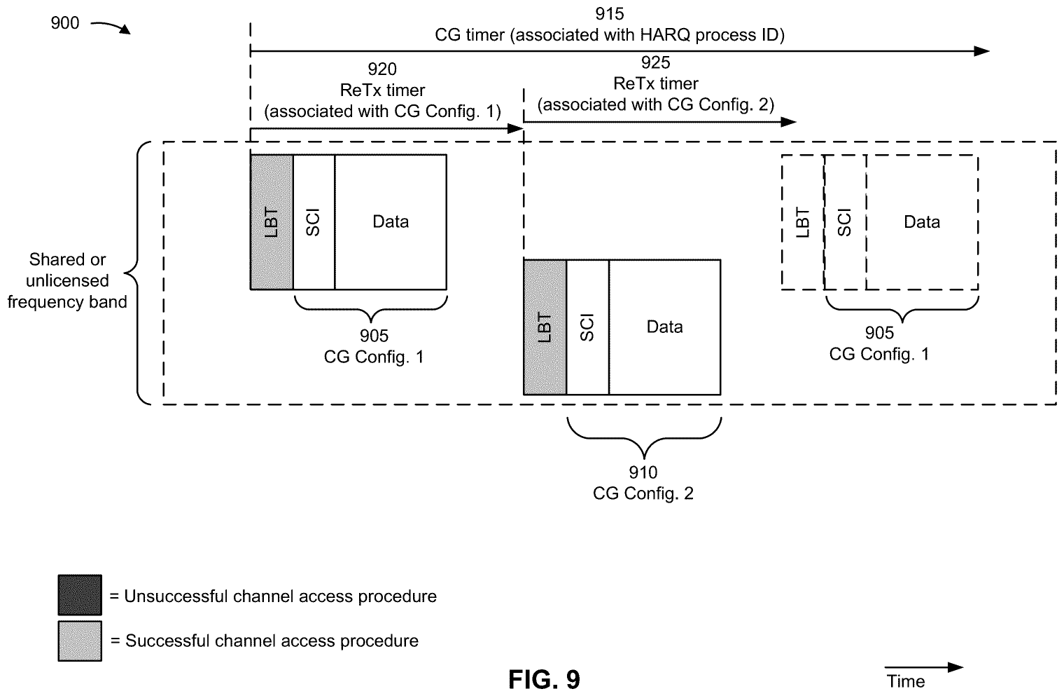

In some aspects, the first UE 705 may initiate another retransmission timer after transmitting the retransmission of the sidelink communication (e.g., transmitted as described above in connection with reference number 765). For example, the first UE 705 may continue to autonomously retransmit the sidelink communication (e.g., in a similar manner as described herein) based at least in part on an expiration of a retransmission timer (e.g., that is initiated each time the first UE 705 successfully performs a transmission or retransmission of the sidelink communication). For example, the first UE 705 may continue to autonomously retransmit the sidelink communication until the CG timer associated with the HARQ process identifier expires. For example, the CG timer and the retransmission timer(s) may be running at overlapping times (e.g., as depicted in FIG. 9). Based at least in part on detecting that the CG timer has expired, the first UE 705 may stop a retransmission timer (e.g., if a retransmission timer is running). The first UE 705 may perform one or more actions based at least in part on detecting that the CG timer has expired.

For example, as shown by reference number 770, the first UE 705 may provide, from the MAC entity associated with the first UE 705 to an upper layer entity associated with the first UE 705, an indication that the CG timer has expired. This may enable the upper layer(s) to interpret the expiration of the CG timer (e.g., as an ACK or NACK) based at least in part on a context associated with the sidelink communication. For example, for Uu interface communications, an expiration of the CG timer may be interpreted as an implicit ACK because the network node 110 may inform the UE 120 if any failures occurred associated with the communication and/or because a receiver may know of the transmission because the receiver may be scheduled to receive the communication. However, in sidelink scenarios, a receiver (e.g., the second UE 710) may not be scheduled to receive the sidelink communication. Instead, the receiver (e.g., the second UE 710) may rely on decoding SCI to identify sidelink communications that are intended for the receiver. Therefore, in some cases, the receiver may not receive the sidelink communication due to failing to decode the SCI or another reason (e.g., a NACK scenario). However, in other cases, the receiver may successfully receive the sidelink communication (e.g., an ACK scenario), but may be unable to transmit a sidelink feedback communication due to a channel access procedure failure.

For example, depending on the context of the sidelink communication, an expiration of the CG timer may be interpreted as an implicit NACK indication or an implicit ACK indication in shared or unlicensed frequency bands. For example, the expiration of the CG timer may be interpreted as an implicit NACK indication in unicast (e.g., one-to-one) scenarios where the PSFCH is configured, or in groupcast scenarios in which feedback (e.g., ACK/NACK feedback) is configured, among other examples. In other cases, the expiration of the CG timer may be interpreted as an implicit ACK indication, such as in groupcast scenarios with NACK only feedback configured, and/or when a retransmission after the expiration of the CG timer may not be useful (such as when the duration of the CG timer is within a threshold amount of, or equal to, a packet delay budget (PDB) associated with the sidelink communication) and an error rate associated with the sidelink communication satisfies a threshold, among other examples.

For example, the first UE 705 may pass an indication that the CG timer has expired from the MAC entity to an upper layer entity (such as an RRC entity, a radio link control (RLC) entity, a packet data convergence protocol (PDCP) entity, and/or a non-access stratum (NAS) entity, among other examples) in a field, such as a CGTExpiry field. This may enable the upper layer(s) to determine how to interpret the expiration of the CG timer, when enabling the MAC entity to remove data or a TB associated with the sidelink communication from the HARQ buffer after the CG timer expires. The first UE 705 (e.g., one or more upper layer entities of the first UE 705) may determine how to interpret the expiration of the CG timer based at least in part on the context or scenario associated with the sidelink communication. The CG timer and/or the retransmission timer may be used by the first UE 705 to control a timing and/or a duration of attempted retransmissions of the sidelink communication. For example, in contrast to an attempted initial transmission of the sidelink communication (such as described in connection with FIG. 7A and reference numbers 720 through 730), the first UE 705 may use one or more timers (e.g., the CG timer and/or the retransmission timer) to determine a timing of a retransmission of the sidelink communication (e.g., based at least in part on an expiration of the retransmission timer) and/or an amount of time for which the first UE 705 is to continue to attempt to transmit (or retransmit) the sidelink communication (e.g., based at least in part on an expiration of the CG timer).

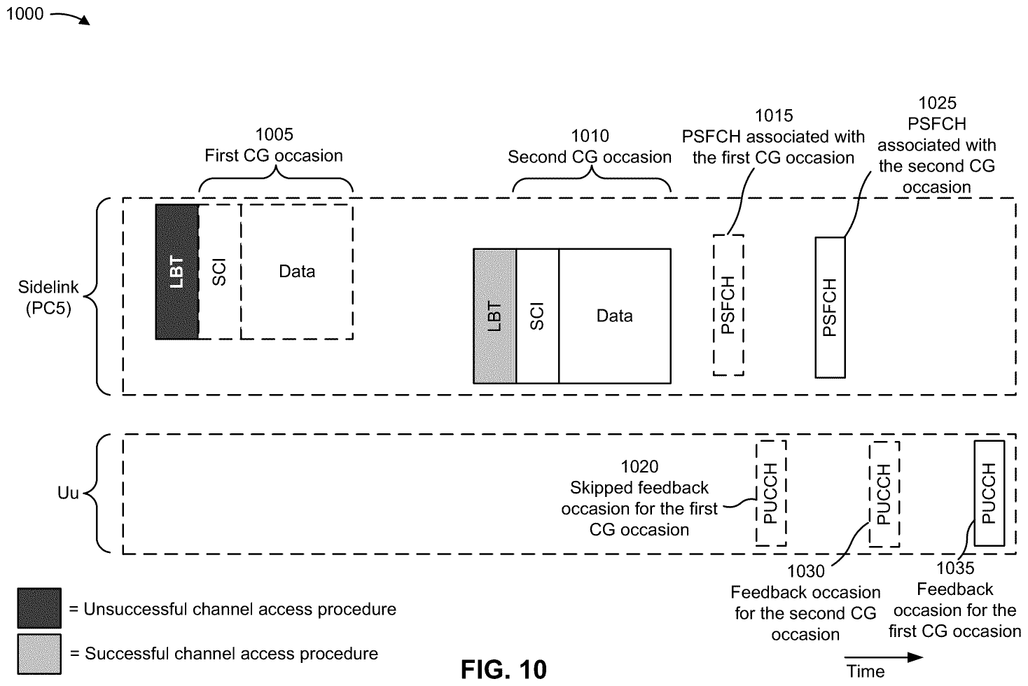

In some aspects, as shown by reference number 775, the first UE 705 may transmit, and the network node 110 may receive, feedback information (e.g., HARQ feedback) associated with the sidelink communication and/or the HARQ feedback identifier. For example, the first UE 705 may use a PUCCH resource to transmit the feedback information. In some aspects, the PUCCH resource may be associated with a configured grant occasion that was initially used to attempt a transmission of the sidelink communication (e.g., the first configured grant configuration described above in connection with reference number 720). In some aspects, the first UE 705 may skip (e.g., refrain from transmitting using) one or more PUCCH resources associated with the first configured grant configuration, such as depicted and described in more detail in connection with FIG. 10.

As indicated above, FIGS. 7A and 7B are provided as examples. Other examples may differ from what is described with respect to FIGS. 7A and 7B.

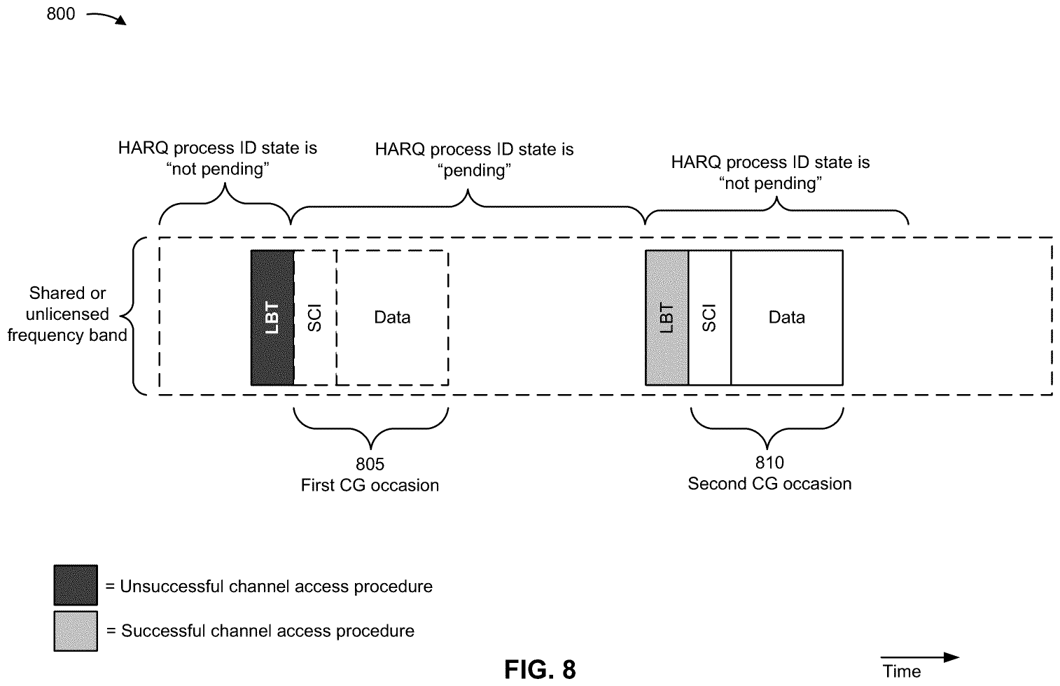

FIG. 8 is a diagram of an example 800 associated with modifying a state of a HARQ process identifier, in accordance with the present disclosure. As shown in FIG. 8, a UE (e.g., a UE 120, the first UE 705, and/or the second UE 710) may change a state of a HARQ process identifier based at least in part on whether a channel access procedure (e.g., an LBT procedure) associated with the HARQ process identifier is successful. For example, as described in more detail elsewhere herein, states associated with a HARQ process may include “pending” and “not pending.”

As shown in FIG. 8, and as described in more detail elsewhere herein, when operating in a shared or unlicensed frequency band, the UE may perform a channel access procedure (e.g., an LBT procedure or another procedure) prior to transmitting using the shared or unlicensed frequency band. For example, as shown in FIG. 8, the UE may attempt to transmit sidelink data or a TB associated with a HARQ process identifier using a first configured grant occasion 805. As shown in FIG. 8, at a time when the UE attempts to transmit the sidelink data or the TB, the state of the HARQ process identifier may be “not pending” (e.g., because the UE is attempting to transmit the sidelink data or the TB). However, the channel access procedure associated with attempting a transmission using resources associated with the first configured grant occasion 805 may be unsuccessful. As a result, the UE may change the state of the HARQ process identifier to “pending” (e.g., because the UE was unable to transmit the sidelink data or the TB using the resources associated with the first configured grant occasion 805 due to the channel access procedure failure).

As shown in FIG. 8, the UE may select the HARQ process identifier to be associated with a second configured grant occasion 810 (e.g., based at least in part on the state of the HARQ process identifier being “pending”). For example, the UE may select the HARQ process identifier from one or more other HARQ process identifiers that are also associated with a “pending” state. The UE may attempt to transmit sidelink data or a TB associated with a HARQ process identifier using the second configured grant occasion 810. For example, the UE may perform a channel access procedure associated with attempting a transmission using resources associated with the second configured grant occasion 810. As shown in FIG. 8, the channel access procedure may be successful. Therefore, the UE may change the state of the HARQ process identifier to “not pending” (e.g., because the UE is able to transmit the sidelink data or the TB using the resources associated with the second configured grant occasion 810).

As indicated above, FIG. 8 is provided as an example. Other examples may differ from what is described with respect to FIG. 8.

FIG. 9 is a diagram of an example 900 associated with timers that are associated with configured grant sidelink communications in a shared or unlicensed frequency band, in accordance with the present disclosure.

As shown in FIG. 9, configured grant sidelink communications in a shared or unlicensed frequency band may be associated with one or more timers, such as a CG timer 915 and/or one or more retransmission (reTx) timers 920 and 925, among other examples. For example, as shown in FIG. 9, a UE (e.g., a UE 120, the first UE 705, and/or the second UE 710) may transmit a sidelink communication in a CG occasion associated with a first configured grant configuration 905. For example, the transmission of the sidelink communication may be an initial transmission of the sidelink communication or may be a retransmission of the sidelink communication following a channel access procedure failure.

As shown in FIG. 9, based at least in part on attempting the transmission of the sidelink communication using the CG occasion associated with the first configured grant configuration 905, the UE may initiate the CG timer 915. As described elsewhere herein, the CG timer 915 may be associated with the HARQ process identifier that is associated with the sidelink communication. For example, the UE may maintain different CG timers for different HARQ process identifiers.

Additionally, based at least in part on attempting the transmission of the sidelink communication using the CG occasion associated with the first configured grant configuration 905, the UE may initiate the retransmission timer 920. The retransmission timer 920 may be associated with the first configured grant configuration 905. As shown in FIG. 9, after an expiration of the retransmission timer 920, the UE may autonomously (e.g., without signaling from a network node 110) retransmit the sidelink communication (e.g., if the UE has not received ACK feedback associated with the sidelink communication). For example, an expiration of the retransmission timer 920 may trigger the UE to perform a retransmission of the sidelink communication using the same configured grant configuration (e.g., the first configured grant configuration 905) or, as shown in FIG. 9, a different configured grant configuration (e.g., a second configured grant configuration 910). For example, without the retransmission timer 920, the UE may have otherwise waited until a next CG occasion associated with the first configured grant configuration 905 (e.g., shown in dashed lines in FIG. 9). The retransmission timer 920 may enable the UE to perform a retransmission of the sidelink communication earlier in time, thereby reducing a latency associated with the sidelink communication.

As shown in FIG. 9, an expiration of the retransmission timer 920 may not cause the CG timer 915 to stop. Based at least in part on attempting the transmission of the sidelink communication using the CG occasion associated with the second configured grant configuration 910, the UE may initiate the retransmission timer 925 (e.g., in a similar manner as described above). After an expiration of the retransmission timer 925, the UE may perform another autonomous retransmission of the sidelink communication in a similar manner as described in more detail elsewhere herein. The UE may continue to perform autonomous retransmission in a similar manner until the CG timer 915 expires or until a condition causing the CG timer 915 to be stopped occurs (e.g., as described in more detail elsewhere herein).

As indicated above, FIG. 9 is provided as an example. Other examples may differ from what is described with respect to FIG. 9.

FIG. 10 is a diagram of an example 1000 associated with network feedback associated with configured grant sidelink communications in a shared or unlicensed frequency band, in accordance with the present disclosure. As shown in FIG. 10, a UE (e.g., a UE 120, the first UE 705, and/or the second UE 710) may be configured to provide feedback to a network node 110 associated with sidelink communications, such as a sidelink communication transmitted using resources associated with a configured grant occasion.

For example, as shown in FIG. 10, the UE may attempt to transmit the sidelink communication using a first configured grant occasion 1005. However, a channel access procedure associated with the attempted transmission may be unsuccessful. Therefore, the UE may refrain from transmitting the sidelink communication using the first configured grant occasion 1005. Using one or more operations or techniques described in more detail elsewhere herein, the UE may perform a retransmission of the sidelink communication using a second configured grant occasion 1010. The first configured grant occasion 1005 and the second configured grant occasion 1010 may be associated with different configured grant configurations. For example, as shown in FIG. 10, the first configured grant occasion 1005 may be associated with a PSFCH resource 1015 that is associated with a receiver UE (e.g., the second UE 710) providing feedback (e.g., HARQ feedback) associated with a sidelink communication that is transmitted using the first configured grant occasion 1005. However, because the UE was unable to transmit the sidelink communication using the first configured grant occasion 1005 (e.g., because of the channel access procedure failure), no feedback may be communicated using the PSFCH resource 1015.

As shown in FIG. 10, the first configured grant occasion 1005 may be associated with a first uplink resource 1020 (e.g., a PUCCH resource) that is associated with transmitting feedback, to a network node 110, associated with the sidelink communication that is transmitted using the first configured grant occasion 1005. However, as described above, because the UE was unable to transmit the sidelink communication using the first configured grant occasion 1005 (e.g., because of the channel access procedure failure), the UE may not have any feedback information to be transmitted via the first uplink resource 1020. Additionally, the second configured grant occasion 1010 may be associated with a second uplink resource 1030 (e.g., a second PUCCH resources). Therefore, there may be redundant uplink resources available for the UE to provide feedback to the network node 110 associated with the same sidelink communication. However, the network node 110 may expect the feedback to be transmitted via an uplink resource associated with the first configured grant occasion 1005. Therefore, to ensure that network resources are utilized efficiently and to ensure that the network node 110 is enabled to identify the feedback information correctly, one or more uplink resources may be skipped by the UE.

For example, the UE may refrain from transmitting feedback associated with the first configured grant configuration and the sidelink communication using the first uplink resource 1020, of one or more uplink resources associated with the first configured grant occasion 1005, based at least in part on one or more conditions being met. For example, the one or more conditions may include a quantity of sidelink transmissions associated with the UE being less than a maximum quantity of sidelink transmissions (e.g., a sl-MaxTransNum having not reached by the UE), sidelink feedback associated with the retransmission having not been received by the UE (e.g., a retransmission timer is configured and HARQ sharing is allowed and a retransmission for the HARQ process identifier associated with the sidelink communication has been attempted on any CG resource and the UE has not received ACK/NACK feedback from a receiver UE via PSFCH communication), and/or sidelink feedback associated with the first configured grant configuration having not been received based at least in part on the channel access procedure being unsuccessful (e.g., PSFCH via the PSFCH resource 1015 is not received by the UE due to LBT failure), among other examples. In some cases, all of the above described conditions may need to be met in order for the UE to skip (e.g., refrain from transmitting using) the first uplink resource 1020.

As shown in FIG. 10, the UE may receive feedback associated with the sidelink communication via a PSFCH resource 1025 that is associated with the second configured grant occasion 1010. The UE may refrain from transmitting the feedback to the network node using the second uplink resource 1030 (e.g., because the network node may expect the feedback via an uplink resource that is associated with the first configured grant occasion 1005). The UE may transmit to the network node 110, the feedback associated with the first configured grant configuration and the sidelink communication using a third uplink resource 1035 (e.g., that is associated with the first configured grant occasion 1005). In this way, the UE may efficiently utilize the uplink resources. Additionally, the UE may ensure that the network node 110 is enabled to correctly identify the feedback information associated with the sidelink communication.

As indicated above, FIG. 10 is provided as an example. Other examples may differ from what is described with respect to FIG. 10.

FIG. 11 is a diagram of an example 1100 associated with one-shot feedback associated with configured grant sidelink communications in a shared or unlicensed frequency band, in accordance with the present disclosure. As shown in FIG. 11, the network node 110, the first UE 705, and/or the second UE 710 may communicate in a similar manner as described elsewhere herein, such as in connection with FIGS. 7A, 7B, and 8-10.

In some cases, as shown by reference number 1105, the second UE 710 may experience a failure for a channel access procedure associated with a sidelink feedback communication (e.g., a PSFCH communication). The channel access procedure failure associated with the sidelink feedback communication may cause the first UE 705 to indicate NACK feedback to the network node 110 for one or more TBs. For example, the first UE 705 may indicate NACK feedback for any TB that is not associated with ACK feedback from another UE (e.g., the second UE 710). As a result, if the second UE 710 experiences a channel access procedure failure and cannot transmit the sidelink feedback communication, then the first UE 705 may indicate NACK feedback to the network node 110 for a TB associated with the sidelink feedback communication. This may cause the network node to schedule retransmission(s) for the TB, thereby consuming additional network resources and/or processing resources. Additionally, the first UE 705 may continue to store the TB in a HARQ buffer of the first UE 705. As a result, the TB may occupy memory of the HARQ buffer, limiting space in the HARQ buffer for other data that is to be transmitted by the first UE 705 (e.g., thereby increasing latency associated with the other data). Further, signaling overhead associated with rescheduling transmissions of TBs that are not associated with ACK feedback from another UE (e.g., the second UE 710) may consume additional network resources and limit a capacity of the wireless network.

Therefore, in some cases, rather than transmitting a single PSFCH communication for each TB, the second UE 710 may utilize one-shot feedback. “One-shot feedback” may refer to a feedback communication that indicates feedback information for multiple HARQ process identifiers (or all HARQ process identifier associated with a given cell). For example, a one-shot feedback communication may be associated with a Type-3 HARQ codebook report. For example, this may reduce a quantity of retransmissions that may be scheduled by the network because a retransmission may not be scheduled each time a UE experiences a channel access procedure failure associated with a PSFCH communication.

In some cases, the first UE 705 may request the one-shot feedback communication from the second UE 710. For example, as shown by reference number 1110, the first UE 705 may transmit, and the network node 110 may receive, an SR communication requesting resources (e.g., time-frequency resources) associated with transmitting a request, to the second UE 710, for a feedback communication using a HARQ codebook that is associated with multiple HARQ process identifiers (e.g., a Type-3 HARQ codebook). The SR request may be a request for resources on a sidelink channel. As shown by reference number 1115, the network node 110 may transmit, and the first UE 705 may receive, a grant for sidelink resources to be used by the first UE 705 to transmit a one-shot feedback request to the second UE 710.

As shown by reference number 1120, the first UE 705 may transmit, and the second UE 710 may receive, a one-shot feedback request. For example, the first UE 705 may use time-frequency resources indicated by the grant to transmit the one-shot feedback request. The one-shot feedback request may include a request for HARQ feedback using the HARQ codebook (e.g., the Type-3 HARQ codebook). In some implementations, the one-shot feedback request may be included in a sidelink MAC-CE.

As shown by reference number 1125, the second UE 710 may transmit, and the network node 110 may receive, an SR communication requesting sidelink resources associated with transmitting a Type-3 HARQ codebook feedback report (e.g., one-shot feedback communication). As shown by reference number 1130, the network node 110 may transmit, and the second UE 710 may receive, a grant for sidelink resources to be used by the second UE 710 to transmit the Type-3 HARQ codebook feedback report (e.g., the one-shot feedback communication). As shown by reference number 1135, the second UE 710 may transmit, and the first UE 705 may receive, the Type-3 HARQ codebook feedback report (e.g., a feedback communication using a HARQ codebook that is associated with multiple HARQ process identifiers).

In some aspects, the first UE 705 may identify the Type-3 HARQ codebook feedback report based at least in part on a sidelink MAC-CE communication (e.g., transmitted by the second UE 710) that identifies the Type-3 HARQ codebook feedback report. For example, the sidelink MAC-CE communication may be similar to (e.g., or a replica of) a missed PSFCH transmission (e.g., due to a channel access procedure failure) or new Type-3 HARQ codebook report. As another example, the first UE 705 may identify the Type-3 HARQ codebook feedback report based at least in part on SCI (e.g., transmitted by the second UE 710) that identifies the Type-3 HARQ codebook feedback report. The SCI may be similar to SCI-2. The SCI may be similar to (e.g., or a replica of) a missed PSFCH transmission (e.g., due to a channel access procedure failure) or new Type-3 HARQ codebook report.

As indicated above, FIG. 11 is provided as an example. Other examples may differ from what is described with respect to FIG. 11.

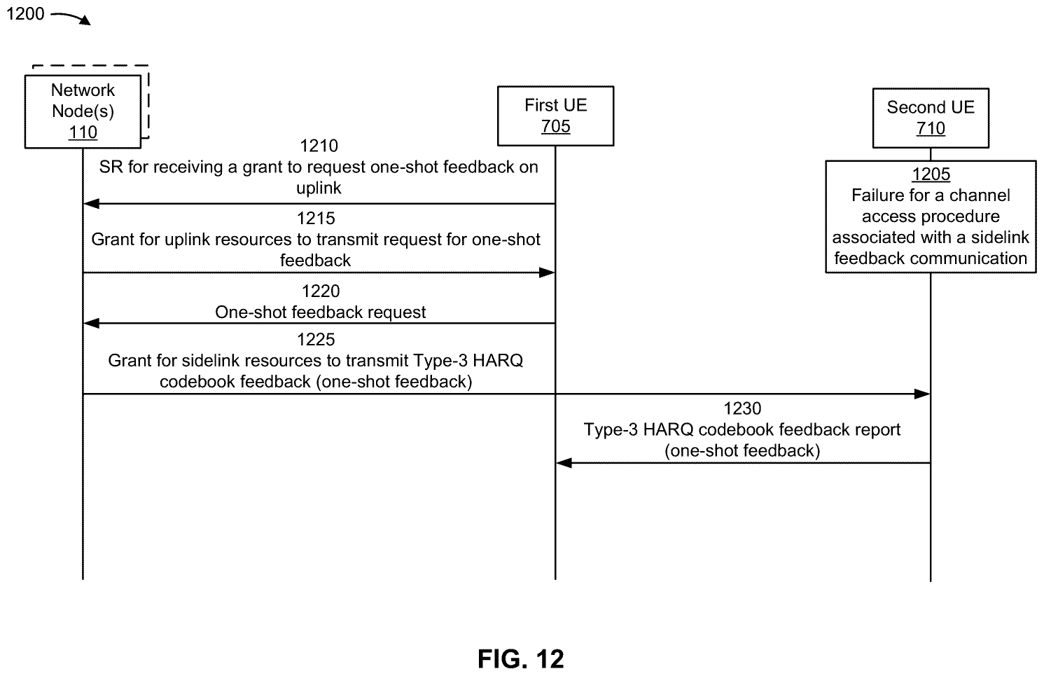

FIG. 12 is a diagram of an example 1200 associated with one-shot feedback associated with configured grant sidelink communications in a shared or unlicensed frequency band, in accordance with the present disclosure. As shown in FIG. 12, the network node 110, the first UE 705, and/or the second UE 710 may communicate in a similar manner as described elsewhere herein, such as in connection with FIGS. 7A, 7B, and 8-11.

In some cases, as shown by reference number 1205, the second UE 710 may experience a failure for a channel access procedure associated with a sidelink feedback communication (e.g., a PSFCH communication). For example, the second UE 710 may experience the channel access procedure failure associated with a sidelink feedback communication (e.g., a PSFCH communication) in a similar manner as described elsewhere herein, such as in connection with FIG. 11 (e.g., and reference number 1105).

In some aspects, the first UE 705 may request one-shot feedback from the second UE 710 by transmitting a request to the network node 110 (e.g., rather than to the second UE 710). For example, as shown by reference number 1210, the first UE 705 may transmit, and the network node 110 may receive, an SR communication requesting resources (e.g., time-frequency resources) associated with transmitting a request, to the network node 110, for a feedback communication from the second UE 710 using a HARQ codebook that is associated with multiple HARQ process identifiers (e.g., a Type-3 HARQ codebook). The SR request may be a request for uplink resources. As shown by reference number 1215, the network node 110 may transmit, and the first UE 705 may receive, a grant for uplink resources to be used by the first UE 705 to transmit a one-shot feedback request to the network node 110.

As shown by reference number 1220, the first UE 705 may transmit, and the network node 110 may receive, a one-shot feedback request. For example, the first UE 705 may use uplink time-frequency resources indicated by the grant to transmit the one-shot feedback request. The one-shot feedback request may include a request for HARQ feedback using the HARQ codebook (e.g., the Type-3 HARQ codebook). In some implementations, the one-shot feedback request may be included in an uplink MAC-CE.

As shown by reference number 1225, the network node 110 may transmit, and the second UE 710 may receive, a grant for sidelink resources and an indication to transmit a Type-3 HARQ codebook feedback (e.g., a one-shot feedback communication) to the first UE 705. For example, the network node 110 may transmit, and the second UE 710 may receive, a request to transmit the feedback communication to the first UE 705 and an indication of one or more sidelink resources associated with the feedback communication. As shown by reference number 1230, the second UE 710 may transmit, and the first UE 705 may receive, the Type-3 HARQ codebook feedback report (e.g., a feedback communication using a HARQ codebook that is associated with multiple HARQ process identifiers). For example, the second UE 710 may use the one or more sidelink resources indicated by the network node to transmit the Type-3 HARQ codebook feedback report. The first UE 705 may identify the Type-3 HARQ codebook feedback report in a similar manner as described elsewhere herein.

As indicated above, FIG. 12 is provided as an example. Other examples may differ from what is described with respect to FIG. 12.

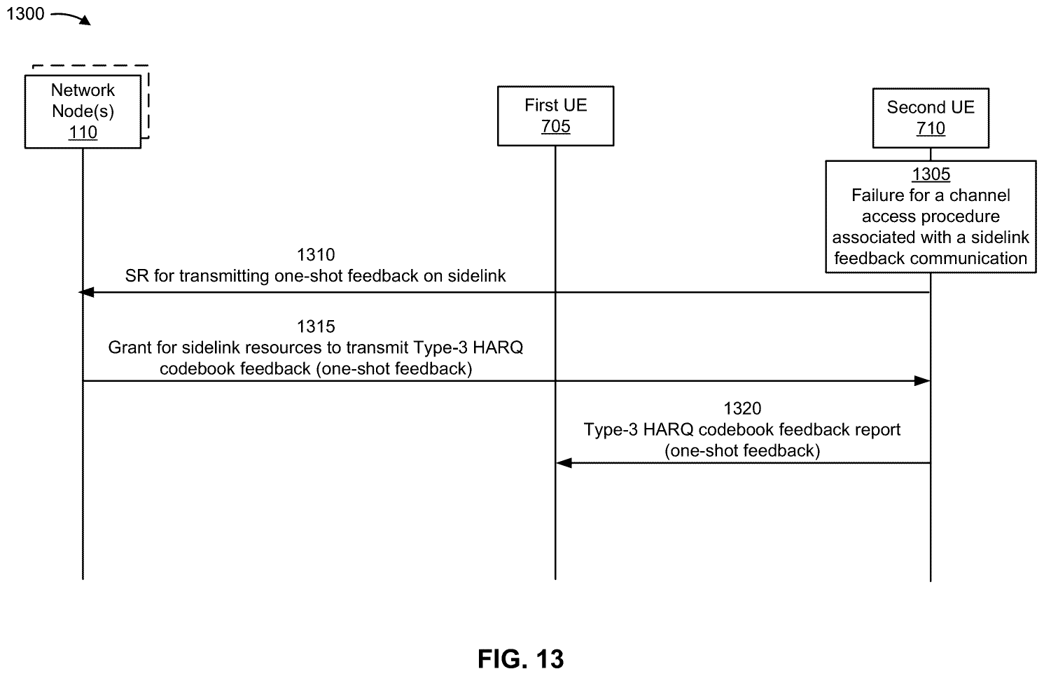

FIG. 13 is a diagram of an example 1300 associated with one-shot feedback associated with configured grant sidelink communications in a shared or unlicensed frequency band, in accordance with the present disclosure. As shown in FIG. 13, the network node 110, the first UE 705, and/or the second UE 710 may communicate in a similar manner as described elsewhere herein, such as in connection with FIGS. 7A, 7B, and 8-12.

In some cases, as shown by reference number 1305, the second UE 710 may experience a failure for a channel access procedure associated with a sidelink feedback communication (e.g., a PSFCH communication). For example, the second UE 710 may experience the channel access procedure failure associated with a sidelink feedback communication (e.g., a PSFCH communication) in a similar manner as described elsewhere herein, such as in connection with FIG. 11 (e.g., and reference number 1105).

In some aspects, the second UE 710 may determine that a one-shot feedback communication is to be transmitted to the first UE 705. In some aspects, the second UE 710 may transmit the one-shot feedback communication without receiving a request from the first UE 705 and/or from the network node 110. For example, the second UE 710 may determine that a one-shot feedback communication is to be transmitted based at least in part on experiencing one or more channel access procedure failure associated with one or more PSFCH communications. This may reduce a signaling overhead associated with scheduling and/or transmitting the one-shot feedback communication.

For example, as shown by reference number 1310, the second UE 710 may transmit, and the network node 110 may receive, a SR communication requesting sidelink resources associated with transmitting a one-shot feedback communication to the first UE 705. For example, the second UE 710 may transmit, and the network node 110 may receive, a request to grant resources for the second UE for a feedback communication associated with a HARQ codebook that is associated with multiple HARQ process identifiers (e.g., a Type-3 HARQ codebook).

As shown by reference number 1315, the network node 110 may transmit, and the second UE 710 may receive, a grant for sidelink resources and an indication to transmit a Type-3 HARQ codebook feedback (e.g., a one-shot feedback communication) to the first UE 705. For example, the network node 110 may transmit, and the second UE 710 may receive, an indication of one or more sidelink resources associated with the feedback communication. As shown by reference number 1320, the second UE 710 may transmit, and the first UE 705 may receive, the Type-3 HARQ codebook feedback report (e.g., a feedback communication using a HARQ codebook that is associated with multiple HARQ process identifiers). For example, the second UE 710 may use the one or more sidelink resources indicated by the network node to transmit the Type-3 HARQ codebook feedback report. The first UE 705 may identify the Type-3 HARQ codebook feedback report in a similar manner as described elsewhere herein.

As indicated above, FIG. 13 is provided as an example. Other examples may differ from what is described with respect to FIG. 13.

FIG. 14 is a diagram illustrating an example process 1400 performed, for example, by a UE, in accordance with the present disclosure. Example process 1400 is an example where the UE (e.g., the UE 120, the first UE 705, and/or the second UE 710) performs operations associated with configured grant sidelink communications in a shared or unlicensed frequency band.

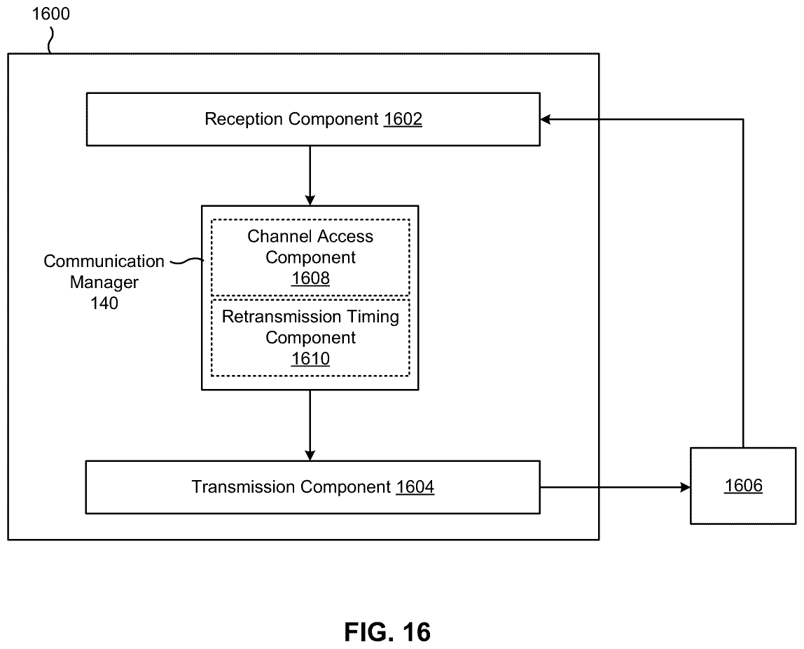

As shown in FIG. 14, in some aspects, process 1400 may include performing a channel access procedure associated with a transmission of a sidelink communication that is to be associated with resources that are associated with a first configured grant configuration, wherein the channel access procedure is unsuccessful, wherein the sidelink communication is associated with a HARQ process identifier, and wherein a state associated with the HARQ process identifier is changed to pending based at least in part on the channel access procedure being unsuccessful (block 1410). For example, the UE (e.g., using communication manager 140 and/or channel access component 1608, depicted in FIG. 16) may perform a channel access procedure associated with a transmission of a sidelink communication that is to be associated with resources that are associated with a first configured grant configuration, wherein the channel access procedure is unsuccessful, wherein the sidelink communication is associated with a HARQ process identifier, and wherein a state associated with the HARQ process identifier is changed to pending based at least in part on the channel access procedure being unsuccessful, as described above.

As further shown in FIG. 14, in some aspects, process 1400 may include transmitting, based at least in part on successfully performing another channel access procedure, a retransmission of the sidelink communication using resources associated with the first configured grant configuration or a second configured grant configuration based at least in part on the state associated with the HARQ process identifier being changed to pending (block 1420). For example, the UE (e.g., using communication manager 140 and/or transmission component 1604, depicted in FIG. 16) may transmit, based at least in part on successfully performing another channel access procedure, a retransmission of the sidelink communication using resources associated with the first configured grant configuration or a second configured grant configuration based at least in part on the state associated with the HARQ process identifier being changed to pending, as described above.

Process 1400 may include additional aspects, such as any single aspect or any combination of aspects described below and/or in connection with one or more other processes described elsewhere herein.

In a first aspect, the channel access procedure includes an LBT procedure.

In a second aspect, alone or in combination with the first aspect, the state associated with the HARQ process identifier is changed to not pending based at least in part on transmitting the retransmission of the sidelink communication.

In a third aspect, alone or in combination with one or more of the first and second aspects, process 1400 includes initiating a timer associated with at least one of the HARQ process identifier or the sidelink communication based at least in part on transmitting the retransmission of the sidelink communication.

In a fourth aspect, alone or in combination with one or more of the first through third aspects, the timer is a configured grant timer.

In a fifth aspect, alone or in combination with one or more of the first through fourth aspects, the timer is associated with an amount of time that the UE is to keep data associated with the sidelink communication stored in a HARQ buffer.

In a sixth aspect, alone or in combination with one or more of the first through fifth aspects, the timer expires after an amount of time associated with the timer, and process 1400 includes at least one of providing, from a MAC entity associated with the UE to an upper layer entity associated with the UE, an indication that the timer has expired, or transmitting, to a network node, an indication that the timer has expired.

In a seventh aspect, alone or in combination with one or more of the first through sixth aspects, an amount of time associated with the timer is based at least in part on a periodicity associated with the first configured grant configuration.

In an eighth aspect, alone or in combination with one or more of the first through seventh aspects, process 1400 includes receiving, from another UE, a sidelink feedback communication indicating that the sidelink communication that is associated with the HARQ process identifier has been successfully received, wherein the timer is stopped based at least in part on receiving the sidelink feedback communication.

In a ninth aspect, alone or in combination with one or more of the first through eighth aspects, process 1400 includes receiving, from a network node, a downlink communication indicating a sidelink grant associated with at least one of the sidelink communication or the HARQ process identifier, wherein the timer is stopped based at least in part on receiving the downlink communication.

In a tenth aspect, alone or in combination with one or more of the first through ninth aspects, a timer is associated with the HARQ process identifier being initiated and is not expired when the channel access procedure associated with the transmission of the sidelink communication is performed, and wherein the timer is stopped based at least in part on the channel access procedure being unsuccessful.

In an eleventh aspect, alone or in combination with one or more of the first through tenth aspects, process 1400 includes initiating a retransmission timer associated with at least one of the HARQ process identifier or the sidelink communication based at least in part on transmitting the retransmission of the sidelink communication.

In a twelfth aspect, alone or in combination with one or more of the first through eleventh aspects, the retransmission timer is associated with an amount of time after which the UE is to automatically transmit another retransmission of the sidelink communication.

In a thirteenth aspect, alone or in combination with one or more of the first through twelfth aspects, the retransmission timer is associated with a configured grant configuration, from the first configured grant configuration or the second configured grant configuration, that is associated with the retransmission of the sidelink communication.

In a fourteenth aspect, alone or in combination with one or more of the first through thirteenth aspects, the timer expires after an amount of time associated with the timer, and process 1400 includes transmitting another retransmission of the sidelink communication using resources associated with the first configured grant configuration, the second configured grant configuration, or a third configured grant configuration based at least in part on the retransmission timer expiring.

In a fifteenth aspect, alone or in combination with one or more of the first through fourteenth aspects, the retransmission of the sidelink communication is transmitted using resources associated with the second configured grant configuration, and wherein an attempted transmission is not counted for the first configured grant configuration.

In a sixteenth aspect, alone or in combination with one or more of the first through fifteenth aspects, the retransmission of the sidelink communication is transmitted using resources associated with the second configured grant configuration, and wherein a logical channel priority associated with the first configured grant configuration is modified based at least in part on the channel access procedure being unsuccessful.

In a seventeenth aspect, alone or in combination with one or more of the first through sixteenth aspects, the retransmission of the sidelink communication is transmitted using resources associated with the second configured grant configuration, and process 1400 includes transmitting, to a network node, an indication that the first configured grant configuration is not used for the sidelink communication or the HARQ process identifier.

In an eighteenth aspect, alone or in combination with one or more of the first through seventeenth aspects, the indication that the first configured grant configuration is not used for the sidelink communication or the HARQ process identifier includes an indication of at least one of that the first configured grant configuration is not used, or an identifier associated with the first configured grant configuration.

In a nineteenth aspect, alone or in combination with one or more of the first through eighteenth aspects, the retransmission of the sidelink communication is transmitted using resources associated with the second configured grant configuration, wherein the first configured grant configuration is associated with one or more uplink resources associated with providing feedback associated with the first configured grant configuration, and process 1400 includes refraining from transmitting feedback associated with the first configured grant configuration and the sidelink communication using a first uplink resource of the one or more uplink resources based at least in part on one or more conditions being met, and transmitting, to a network node, the feedback associated with the first configured grant configuration and the sidelink communication using a second uplink resource of the one or more uplink resources.

In a twentieth aspect, alone or in combination with one or more of the first through nineteenth aspects, the one or more conditions include at least one of a quantity of sidelink transmissions associated with the UE being less than a maximum quantity of sidelink transmissions, sidelink feedback associated with the retransmission having not been received by the UE, or sidelink feedback associated with the first configured grant configuration having not been received based at least in part on the channel access procedure being unsuccessful.

In a twenty-first aspect, alone or in combination with one or more of the first through twentieth aspects, process 1400 includes receiving, from another UE, a feedback communication using a HARQ codebook that is associated with multiple HARQ process identifiers including the HARQ process identifier.

In a twenty-second aspect, alone or in combination with one or more of the first through twenty-first aspects, process 1400 includes transmitting, to the other UE, a request for HARQ feedback using the HARQ codebook, wherein the feedback communication is received based at least in part on transmitting the request.

In a twenty-third aspect, alone or in combination with one or more of the first through twenty-second aspects, the request is included in a sidelink MAC control element communication.

In a twenty-fourth aspect, alone or in combination with one or more of the first through twenty-third aspects, process 1400 includes transmitting, to a network node, a request for HARQ feedback using the HARQ codebook, wherein the feedback communication is received based at least in part on transmitting the request.

In a twenty-fifth aspect, alone or in combination with one or more of the first through twenty-fourth aspects, the HARQ codebook is a Type-3 HARQ codebook.

In a twenty-sixth aspect, alone or in combination with one or more of the first through twenty-fifth aspects, the feedback communication is associated with a sidelink MAC-CE communication or sidelink control information identifying the HARQ codebook.

In a twenty-seventh aspect, alone or in combination with one or more of the first through twenty-sixth aspects, process 1400 includes transmitting, to a network node, an indication of persistent channel access failures based at least in part on a quantity of channel access procedures that are unsuccessful, including the channel access procedure, satisfying a threshold.

In a twenty-eighth aspect, alone or in combination with one or more of the first through twenty-seventh aspects, the indication of persistent channel access failures is included in a MAC control element communication.

In a twenty-ninth aspect, alone or in combination with one or more of the first through twenty-eighth aspects, the quantity of channel access procedures are associated with a same bandwidth part.

In a thirtieth aspect, alone or in combination with one or more of the first through twenty-ninth aspects, process 1400 includes receiving, from a network node, configuration information indicating that HARQ process sharing is enabled and indicating information associated with one or more timers associated with the HARQ process sharing.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram illustrating an example process 1500 performed, for example, by a network node, in accordance with the present disclosure. Example process 1500 is an example where the network node (e.g., the network node 110) performs operations associated with configured grant sidelink communications in a shared or unlicensed frequency band.

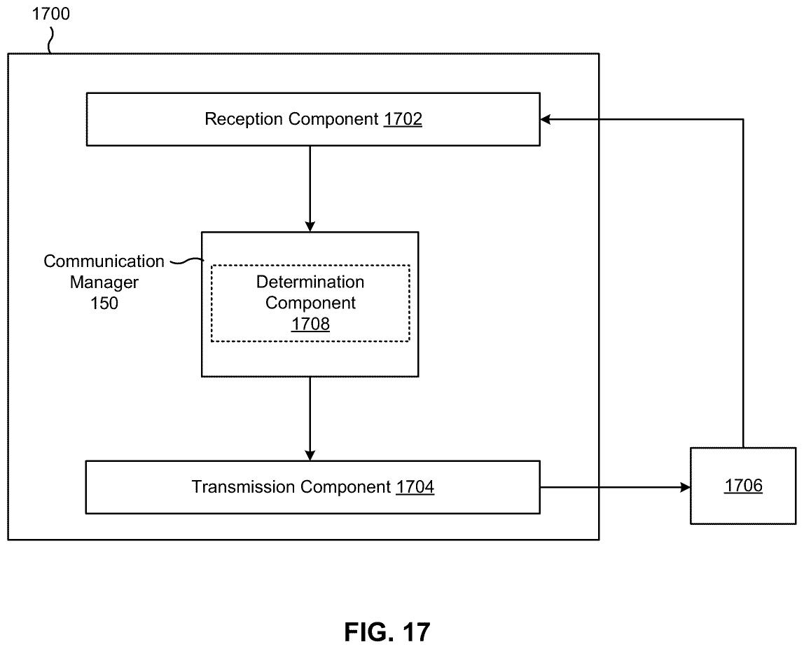

As shown in FIG. 15, in some aspects, process 1500 may include transmitting, to a first UE, configuration information indicating that HARQ process sharing is enabled and indicating information associated with one or more timers associated with the HARQ process sharing, wherein the configuration information indicates information associated with at least one of a first configured grant configuration or a second configured grant configuration (block 1510). For example, the network node (e.g., using communication manager 150 and/or transmission component 1704, depicted in FIG. 17) may transmit, to a first UE, configuration information indicating that HARQ process sharing is enabled and indicating information associated with one or more timers associated with the HARQ process sharing, wherein the configuration information indicates information associated with at least one of a first configured grant configuration or a second configured grant configuration, as described above.

As further shown in FIG. 15, in some aspects, process 1500 may include receiving, from the first UE, feedback information associated with a sidelink communication that is associated with the first configured grant configuration, wherein the sidelink communication was transmitted via the second configured grant configuration (block 1520). For example, the network node (e.g., using communication manager 150 and/or reception component 1702, depicted in FIG. 17) may receive, from the first UE, feedback information associated with a sidelink communication that is associated with the first configured grant configuration, wherein the sidelink communication was transmitted via the second configured grant configuration, as described above. In some aspects, the sidelink communication was transmitted via a second configured grant configuration.

Process 1500 may include additional aspects, such as any single aspect or any combination of aspects described below and/or in connection with one or more other processes described elsewhere herein.

In a first aspect, the one or more timers include at least one of a configured grant timer or a retransmission timer.

In a second aspect, alone or in combination with the first aspect, process 1500 includes receiving, from the first UE, an indication that the first configured grant configuration is not used for the sidelink communication.

In a third aspect, alone or in combination with one or more of the first and second aspects, the indication that the first configured grant configuration is not used for the sidelink communication includes an indication of at least one of that the first configured grant configuration is not used, or an identifier associated with the first configured grant configuration.

In a fourth aspect, alone or in combination with one or more of the first through third aspects, process 1500 includes receiving, from the first UE, a request to grant resources for a second UE for a feedback communication associated with a HARQ codebook that is associated with multiple HARQ process identifiers, and transmitting, to the second UE, a request to transmit the feedback communication to the first UE and an indication of one or more sidelink resources associated with the feedback communication.

In a fifth aspect, alone or in combination with one or more of the first through fourth aspects, the feedback information associated with the sidelink communication is based at least in part on the feedback communication.

In a sixth aspect, alone or in combination with one or more of the first through fifth aspects, the HARQ codebook is a type-3 HARQ codebook.

In a seventh aspect, alone or in combination with one or more of the first through sixth aspects, process 1500 includes receiving, from a second UE, a request to grant resources for the second UE for a feedback communication associated with a HARQ codebook that is associated with multiple HARQ process identifiers, and transmitting, to the second UE, an indication of one or more sidelink resources associated with the feedback communication.

In an eighth aspect, alone or in combination with one or more of the first through seventh aspects, process 1500 includes receiving, from the first UE, an indication of persistent channel access failures based at least in part on a quantity of channel access procedures that are unsuccessful satisfying a threshold.

In a ninth aspect, alone or in combination with one or more of the first through eighth aspects, the indication of persistent channel access failures is included in a MAC control element communication.

In a tenth aspect, alone or in combination with one or more of the first through ninth aspects, the quantity of channel access procedures are associated with a same bandwidth part.

In an eleventh aspect, alone or in combination with one or more of the first through tenth aspects, process 1500 includes performing an action based at least in part on receiving the indication of persistent channel access failures.

In a twelfth aspect, alone or in combination with one or more of the first through eleventh aspects, the action includes causing the first UE to change a bandwidth part, a bandwidth, or a frequency band used by the first UE.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram of an example apparatus 1600 for wireless communication, in accordance with the present disclosure. The apparatus 1600 may be a UE, or a UE may include the apparatus 1600. In some aspects, the apparatus 1600 includes a reception component 1602 and a transmission component 1604, which may be in communication with one another (for example, via one or more buses and/or one or more other components). As shown, the apparatus 1600 may communicate with another apparatus 1606 (such as a UE, a base station, a network node, or another wireless communication device) using the reception component 1602 and the transmission component 1604. As further shown, the apparatus 1600 may include the communication manager 140. The communication manager 140 may include one or more of a channel access component 1608, and/or a retransmission timing component 1610, among other examples.

In some aspects, the apparatus 1600 may be configured to perform one or more operations described herein in connection with FIGS. 7A, 7B, and 8-13. Additionally, or alternatively, the apparatus 1600 may be configured to perform one or more processes described herein, such as process 1400 of FIG. 14, or a combination thereof. In some aspects, the apparatus 1600 and/or one or more components shown in FIG. 16 may include one or more components of the UE described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1606. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, a modem, a demodulator, a MIMO detector, a receive processor, a controller/processor, a memory, or a combination thereof, of the UE described in connection with FIG. 2.

The transmission component 1604 may transmit communications, such as reference signals, control information, data communications, or a combination thereof, to the apparatus 1606. In some aspects, one or more other components of the apparatus 1600 may generate communications and may provide the generated communications to the transmission component 1604 for transmission to the apparatus 1606. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1606. In some aspects, the transmission component 1604 may include one or more antennas, a modem, a modulator, a transmit MIMO processor, a transmit processor, a controller/processor, a memory, or a combination thereof, of the UE described in connection with FIG. 2. In some aspects, the transmission component 1604 may be co-located with the reception component 1602 in a transceiver.

The channel access component 1608 may perform a channel access procedure associated with a transmission of a sidelink communication that is to be associated with resources that are associated with a first configured grant configuration, wherein the channel access procedure is unsuccessful, wherein the sidelink communication is associated with a HARQ process identifier, and wherein a state associated with the HARQ process identifier is changed to pending based at least in part on the channel access procedure being unsuccessful. The transmission component 1604 may transmit, based at least in part on successfully performing another channel access procedure, a retransmission of the sidelink communication using resources associated with the first configured grant configuration or a second configured grant configuration based at least in part on the state associated with the HARQ process identifier being changed to pending.

The retransmission timing component 1610 may initiate a timer associated with at least one of the HARQ process identifier or the sidelink communication based at least in part on transmitting the retransmission of the sidelink communication.

The reception component 1602 may receive, from another UE, a sidelink feedback communication indicating that the sidelink communication that is associated with the HARQ process identifier has been successfully received, wherein the timer is stopped based at least in part on receiving the sidelink feedback communication.

The reception component 1602 may receive, from a network node, a downlink communication indicating a sidelink grant associated with at least one of the sidelink communication or the HARQ process identifier, wherein the timer is stopped based at least in part on receiving the downlink communication.

The retransmission timing component 1610 may initiate a retransmission timer associated with at least one of the HARQ process identifier or the sidelink communication based at least in part on transmitting the retransmission of the sidelink communication.

The reception component 1602 may receive, from another UE, a feedback communication using a HARQ codebook that is associated with multiple HARQ process identifiers including the HARQ process identifier.

The transmission component 1604 may transmit, to the other UE, a request for HARQ feedback using the HARQ codebook, wherein the feedback communication is received based at least in part on transmitting the request.

The transmission component 1604 may transmit, to a network node, a request for HARQ feedback using the HARQ codebook, wherein the feedback communication is received based at least in part on transmitting the request.

The transmission component 1604 may transmit, to a network node, an indication of persistent channel access failures based at least in part on a quantity of channel access procedures that are unsuccessful, including the channel access procedure, satisfying a threshold.

The reception component 1602 may receive, from a network node, configuration information indicating that HARQ process sharing is enabled and indicating information associated with one or more timers associated with the HARQ process sharing.

The quantity and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

FIG. 17 is a diagram of an example apparatus 1700 for wireless communication, in accordance with the present disclosure. The apparatus 1700 may be a network node, or a network node may include the apparatus 1700. In some aspects, the apparatus 1700 includes a reception component 1702 and a transmission component 1704, which may be in communication with one another (for example, via one or more buses and/or one or more other components). As shown, the apparatus 1700 may communicate with another apparatus 1706 (such as a UE, a base station, a network node, or another wireless communication device) using the reception component 1702 and the transmission component 1704. As further shown, the apparatus 1700 may include the communication manager 150. The communication manager 150 may include a determination component 1708, among other examples.

In some aspects, the apparatus 1700 may be configured to perform one or more operations described herein in connection with FIGS. 7A, 7B, and 8-13. Additionally, or alternatively, the apparatus 1700 may be configured to perform one or more processes described herein, such as process 1500 of FIG. 15, or a combination thereof. In some aspects, the apparatus 1700 and/or one or more components shown in FIG. 17 may include one or more components of the network node described in connection with FIG. 2. Additionally, or alternatively, one or more components shown in FIG. 17 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1702 may receive communications, such as reference signals, control information, data communications, or a combination thereof, from the apparatus 1706. The reception component 1702 may provide received communications to one or more other components of the apparatus 1700. In some aspects, the reception component 1702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1700. In some aspects, the reception component 1702 may include one or more antennas, a modem, a demodulator, a MIMO detector, a receive processor, a controller/processor, a memory, or a combination thereof, of the network node described in connection with FIG. 2. In some aspects, the reception component 1702 may include or be included in an interface for communication with another apparatus, such as a network node.

The transmission component 1704 may transmit communications, such as reference signals, control information, data communications, or a combination thereof, to the apparatus 1706. In some aspects, one or more other components of the apparatus 1700 may generate communications and may provide the generated communications to the transmission component 1704 for transmission to the apparatus 1706. In some aspects, the transmission component 1704 may perform signal processing on the generated communications (such as filtering, amplification, modulation, digital-to-analog conversion, multiplexing, interleaving, mapping, or encoding, among other examples), and may transmit the processed signals to the apparatus 1706. In some aspects, the transmission component 1704 may include one or more antennas, a modem, a modulator, a transmit MIMO processor, a transmit processor, a controller/processor, a memory, or a combination thereof, of the network node described in connection with FIG. 2. In some aspects, the transmission component 1704 may be co-located with the reception component 1702 in a transceiver. In some aspects, the transmission component 1704 may include or be included in an interface for communication with another apparatus, such as a network node. In some aspects, the transmission component 1704 and/or the reception component 1702 may facilitate communication with one or more network nodes. For example, the transmission component 1704 and/or the reception component 1702 may not perform direct radio communication with a UE and/or the apparatus 1706. In some other aspects, the transmission component 1704 and/or the reception component 1702 may perform direct radio communication with a UE and/or the apparatus 1706.

The transmission component 1704 may transmit, to a first UE, configuration information indicating that HARQ process sharing is enabled and indicating information associated with one or more timers associated with the HARQ process sharing. The reception component 1702 may receive, from the first UE, feedback information associated with a sidelink communication that is associated with a first configured grant configuration wherein the sidelink communication was transmitted via a second configured grant configuration.

The determination component 1708 may determine the configuration information.

The reception component 1702 may receive, from the first UE, an indication that the first configured grant configuration is not used for the sidelink communication.

The reception component 1702 may receive, from the first UE, a request to grant resources for a second UE for a feedback communication associated with a HARQ codebook that is associated with multiple HARQ process identifiers.

The transmission component 1704 may transmit, to the second UE, a request to transmit the feedback communication to the first UE and an indication of one or more sidelink resources associated with the feedback communication.

The reception component 1702 may receive, from a second UE, a request to grant resources for the second UE for a feedback communication associated with a HARQ codebook that is associated with multiple HARQ process identifiers.

The transmission component 1704 may transmit, to the second UE, an indication of one or more sidelink resources associated with the feedback communication.

The reception component 1702 may receive, from the first UE, an indication of persistent channel access failures based at least in part on a quantity of channel access procedures that are unsuccessful satisfying a threshold.

The determination component 1708 may perform an action based at least in part on receiving the indication of persistent channel access failures.

The quantity and arrangement of components shown in FIG. 17 are provided as an example. In practice, there may be additional components, fewer components, different components, or differently arranged components than those shown in FIG. 17. Furthermore, two or more components shown in FIG. 17 may be implemented within a single component, or a single component shown in FIG. 17 may be implemented as multiple, distributed components. Additionally, or alternatively, a set of (one or more) components shown in FIG. 17 may perform one or more functions described as being performed by another set of components shown in FIG. 17.

The following provides an overview of some Aspects of the present disclosure:

Aspect 1: A method of wireless communication performed by a user equipment (UE), comprising: performing a channel access procedure associated with a transmission of a sidelink communication that is to be associated with resources that are associated with a first configured grant configuration, wherein the channel access procedure is unsuccessful, wherein the sidelink communication is associated with a hybrid automatic repeat request (HARQ) process identifier, and wherein a state associated with the HARQ process identifier is changed to pending based at least in part on the channel access procedure being unsuccessful; and transmitting, based at least in part on successfully performing another channel access procedure, a retransmission of the sidelink communication using resources associated with the first configured grant configuration or a second configured grant configuration based at least in part on the state associated with the HARQ process identifier being changed to pending.

Aspect 2: The method of Aspect 1, wherein the channel access procedure includes a listen-before-talk (LBT) procedure.

Aspect 3: The method of any of Aspects 1-2, wherein the state associated with the HARQ process identifier is changed to not pending based at least in part on transmitting the retransmission of the sidelink communication.

Aspect 4: The method of any of Aspects 1-3, further comprising: initiating a timer associated with at least one of the HARQ process identifier or the sidelink communication based at least in part on transmitting the retransmission of the sidelink communication.

Aspect 5: The method of Aspect 4, wherein the timer is a configured grant timer.

Aspect 6: The method of any of Aspects 4-5, wherein the timer is associated with an amount of time that the UE is to keep data associated with the sidelink communication stored in a HARQ buffer.

Aspect 7: The method of any of Aspects 4-6, further comprising at least one of: providing, from a medium access control (MAC) entity associated with the UE to an upper layer entity associated with the UE based at least in part on the timer expiring, an indication that the timer has expired; or transmitting, to a network node, an indication that the timer has expired based at least in part on the timer expiring.

Aspect 8: The method of any of Aspects 4-7, wherein an amount of time associated with the timer is based at least in part on a periodicity associated with the first configured grant configuration.

Aspect 9: The method of any of Aspects 4-8, further comprising: receiving, from another UE, a sidelink feedback communication indicating that the sidelink communication that is associated with the HARQ process identifier has been successfully received, wherein the timer is stopped based at least in part on receiving the sidelink feedback communication.

Aspect 10: The method of any of Aspects 4-9, further comprising: receiving, from a network node, a downlink communication indicating a sidelink grant associated with at least one of the sidelink communication or the HARQ process identifier, wherein the timer is stopped based at least in part on receiving the downlink communication.

Aspect 11: The method of any of Aspects 1-10, wherein a timer is associated with the HARQ process identifier being initiated and is not expired when the channel access procedure associated with the transmission of the sidelink communication is performed, and wherein the timer is stopped based at least in part on the channel access procedure being unsuccessful.

Aspect 12: The method of any of Aspects 1-11, further comprising: initiating a retransmission timer associated with at least one of the HARQ process identifier or the sidelink communication based at least in part on transmitting the retransmission of the sidelink communication.

Aspect 13: The method of Aspect 12, wherein the retransmission timer is associated with an amount of time after which the UE is to automatically transmit another retransmission of the sidelink communication.

Aspect 14: The method of any of Aspects 12-13, wherein the retransmission timer is associated with a configured grant configuration, from the first configured grant configuration or the second configured grant configuration, that is associated with the retransmission of the sidelink communication.

Aspect 15: The method of any of Aspects 12-14, further comprising: transmitting another retransmission of the sidelink communication using resources associated with the first configured grant configuration, the second configured grant configuration, or a third configured grant configuration based at least in part on the retransmission timer expiring.

Aspect 16: The method of any of Aspects 1-15, wherein the retransmission of the sidelink communication is transmitted using resources associated with the second configured grant configuration, and wherein an attempted transmission is not counted for the first configured grant configuration.

Aspect 17: The method of any of Aspects 1-16, wherein the retransmission of the sidelink communication is transmitted using resources associated with the second configured grant configuration, and wherein a logical channel priority associated with the first configured grant configuration is modified based at least in part on the channel access procedure being unsuccessful.

Aspect 18: The method of any of Aspects 1-17, wherein the retransmission of the sidelink communication is transmitted using resources associated with the second configured grant configuration, the method further comprising: transmitting, to a network node, an indication that the first configured grant configuration is not used for the sidelink communication or the HARQ process identifier.

Aspect 19: The method of Aspect 18, wherein the indication that the first configured grant configuration is not used for the sidelink communication or the HARQ process identifier includes an indication of at least one of: that the first configured grant configuration is not used, or an identifier associated with the first configured grant configuration.

Aspect 20: The method of any of Aspects 1-19, wherein the retransmission of the sidelink communication is transmitted using resources associated with the second configured grant configuration, wherein the first configured grant configuration is associated with one or more uplink resources associated with providing feedback associated with the first configured grant configuration, and the method further comprising: refraining from transmitting feedback associated with the first configured grant configuration and the sidelink communication using a first uplink resource of the one or more uplink resources based at least in part on one or more conditions being met; and transmitting, to a network node, the feedback associated with the first configured grant configuration and the sidelink communication using a second uplink resource of the one or more uplink resources.

Aspect 21: The method of Aspect 20, wherein the one or more conditions include at least one of: a quantity of sidelink transmissions associated with the UE being less than a maximum quantity of sidelink transmissions, sidelink feedback associated with the retransmission having not been received by the UE, or sidelink feedback associated with the first configured grant configuration having not been received based at least in part on the channel access procedure being unsuccessful.

Aspect 22: The method of any of Aspects 1-21, further comprising: receiving, from another UE, a feedback communication using a HARQ codebook that is associated with multiple HARQ process identifiers including the HARQ process identifier.

Aspect 23: The method of Aspect 22, further comprising: transmitting, to the other UE, a request for HARQ feedback using the HARQ codebook, wherein the feedback communication is received based at least in part on transmitting the request.

Aspect 24: The method of Aspect 23, wherein the request is included in a sidelink medium access control (MAC) control element communication.

Aspect 25: The method of any of Aspects 22-24, further comprising: transmitting, to a network node, a request for HARQ feedback using the HARQ codebook, wherein the feedback communication is received based at least in part on transmitting the request.

Aspect 26: The method of any of Aspects 22-25, wherein the HARQ codebook is a Type-3 HARQ codebook.

Aspect 27: The method of any of Aspects 22-26, wherein the feedback communication is associated with a sidelink medium access control (MAC) control element communication or sidelink control information identifying the HARQ codebook.

Aspect 28: The method of any of Aspects 1-27, further comprising: transmitting, to a network node, an indication of persistent channel access failures based at least in part on a quantity of channel access procedures that are unsuccessful, including the channel access procedure, satisfying a threshold.

Aspect 29: The method of Aspect 28, wherein the indication of persistent channel access failures is included in a medium access control (MAC) control element communication.

Aspect 30: The method of any of Aspects 28-29, wherein the quantity of channel access procedures are associated with a same bandwidth part.

Aspect 31: The method of any of Aspects 1-30, further comprising: receiving, from a network node, configuration information indicating that HARQ process sharing is enabled and indicating information associated with one or more timers associated with the HARQ process sharing.

Aspect 32: A method of wireless communication performed by a network node, comprising: transmitting, to a first user equipment (UE), configuration information indicating that hybrid automatic repeat request (HARQ) process sharing is enabled and indicating information associated with one or more timers associated with the HARQ process sharing, wherein the configuration information indicates information associated with at least one of a first configured grant configuration or a second configured grant configuration; and receiving, from the first UE, feedback information associated with a sidelink communication that is associated with the first configured grant configuration, wherein the sidelink communication was transmitted via the second configured grant configuration.

Aspect 33: The method of Aspect 32, wherein the one or more timers include at least one of a configured grant timer or a retransmission timer.

Aspect 34: The method of any of Aspects 32-33, further comprising: receiving, from the first UE, an indication that the first configured grant configuration is not used for the sidelink communication.

Aspect 35: The method of Aspect 34, wherein the indication that the first configured grant configuration is not used for the sidelink communication includes an indication of at least one of: that the first configured grant configuration is not used, or an identifier associated with the first configured grant configuration.

Aspect 36: The method of any of Aspects 32-35, further comprising: receiving, from the first UE, a request to grant resources for a second UE for a feedback communication associated with a HARQ codebook that is associated with multiple HARQ process identifiers; and transmitting, to the second UE, a request to transmit the feedback communication to the first UE and an indication of one or more sidelink resources associated with the feedback communication.

Aspect 37: The method of Aspect 36, wherein the feedback information associated with the sidelink communication is based at least in part on the feedback communication.

Aspect 38: The method of any of Aspects 36-37, wherein the HARQ codebook is a type-3 HARQ codebook.

Aspect 39: The method of any of Aspects 32-38, further comprising: receiving, from a second UE, a request to grant resources for the second UE for a feedback communication associated with a HARQ codebook that is associated with multiple HARQ process identifiers; and transmitting, to the second UE, an indication of one or more sidelink resources associated with the feedback communication.

Aspect 40: The method of any of Aspects 32-39, further comprising: receiving, from the first UE, an indication of persistent channel access failures based at least in part on a quantity of channel access procedures that are unsuccessful satisfying a threshold.

Aspect 41: The method of Aspect 40, wherein the indication of persistent channel access failures is included in a medium access control (MAC) control element communication.

Aspect 42: The method of any of Aspects 40-41, wherein the quantity of channel access procedures are associated with a same bandwidth part.

Aspect 43: The method of any of Aspects 40-42, further comprising:
performing an action based at least in part on receiving the indication of persistent channel access failures.

Aspect 44: The method of Aspect 43, wherein the action includes causing the first UE to change a bandwidth part, a bandwidth, or a frequency band used by the first UE.

Aspect 45: An apparatus for wireless communication at a device, comprising a processor; memory coupled with the processor; and instructions stored in the memory and executable by the processor to cause the apparatus to perform the method of one or more of Aspects 1-31.

Aspect 46: A device for wireless communication, comprising a memory and one or more processors coupled to the memory, the one or more processors configured to perform the method of one or more of Aspects 1-31.

Aspect 47: An apparatus for wireless communication, comprising at least one means for performing the method of one or more of Aspects 1-31.

Aspect 48: A non-transitory computer-readable medium storing code for wireless communication, the code comprising instructions executable by a processor to perform the method of one or more of Aspects 1-31.

Aspect 49: A non-transitory computer-readable medium storing a set of instructions for wireless communication, the set of instructions comprising one or more instructions that, when executed by one or more processors of a device, cause the device to perform the method of one or more of Aspects 1-31.

Aspect 50: An apparatus for wireless communication at a device, comprising a processor; memory coupled with the processor; and instructions stored in the memory and executable by the processor to cause the apparatus to perform the method of one or more of Aspects 32-44.

Aspect 51: A device for wireless communication, comprising a memory and one or more processors coupled to the memory, the one or more processors configured to perform the method of one or more of Aspects 32-44.

Aspect 52: An apparatus for wireless communication, comprising at least one means for performing the method of one or more of Aspects 32-44.

Aspect 53: A non-transitory computer-readable medium storing code for wireless communication, the code comprising instructions executable by a processor to perform the method of one or more of Aspects 32-44.

Aspect 54: A non-transitory computer-readable medium storing a set of instructions for wireless communication, the set of instructions comprising one or more instructions that, when executed by one or more processors of a device, cause the device to perform the method of one or more of Aspects 32-44.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. A user equipment (UE) for wireless communication, comprising:
a memory; and
one or more processors, coupled to the memory, configured to cause the UE to:
perform a channel access procedure associated with a transmission of a sidelink communication that is to be associated with resources that are associated with a first configured grant configuration, wherein the channel access procedure is unsuccessful, wherein the sidelink communication is associated with a hybrid automatic repeat request (HARQ) process identifier, and wherein a state associated with the HARQ process identifier is changed to pending based at least in part on the channel access procedure being unsuccessful; and
transmit, based at least in part on successfully performing another channel access procedure, a retransmission of the sidelink communication using resources associated with the first configured grant configuration or a second configured grant configuration based at least in part on the state associated with the HARQ process identifier being changed to pending.

2. The UE of claim 1, wherein the one or more processors are further configured to cause the UE to:
initiate a timer associated with at least one of the HARQ process identifier or the sidelink communication based at least in part on transmitting the retransmission of the sidelink communication, wherein the timer is associated with an amount of time that the UE is to keep data associated with the sidelink communication stored in a HARQ buffer.

3. The UE of claim 2, wherein the one or more processors are further configured to cause the UE to at least one of:
provide, from a medium access control (MAC) entity associated with the UE to an upper layer entity associated with the UE, an indication that the timer has expired based at least in part on the timer expiring; or
transmit, to a network node, an indication that the timer has expired based at least in part on the timer expiring.

4. The UE of claim 2, wherein the one or more processors are further configured to cause the UE to:
receive, from another UE, a sidelink feedback communication indicating that the sidelink communication that is associated with the HARQ process identifier has been successfully received, wherein the timer is stopped based at least in part on receiving the sidelink feedback communication.

5. The UE of claim 1, wherein a timer is associated with the HARQ process identifier being initiated and is not expired when the channel access procedure associated with the transmission of the sidelink communication is performed, and wherein the timer is stopped based at least in part on the channel access procedure being unsuccessful.

6. The UE of claim 1, wherein the one or more processors are further configured to cause the UE to:
initiate a retransmission timer associated with at least one of the HARQ process identifier or the sidelink communication based at least in part on transmitting the retransmission of the sidelink communication, wherein the retransmission timer is associated with an amount of time after which the UE is to automatically transmit another retransmission of the sidelink communication.

7. The UE of claim 6, wherein the one or more processors are further configured to cause the UE to:
transmit another retransmission of the sidelink communication using resources associated with the first configured grant configuration, the second configured grant configuration, or a third configured grant configuration based at least in part on the retransmission timer expiring.

8. The UE of claim 1, wherein the retransmission of the sidelink communication is transmitted using resources associated with the second configured grant configuration, and wherein an attempted transmission is not counted for the first configured grant configuration.

9. The UE of claim 1, wherein the retransmission of the sidelink communication is transmitted using resources associated with the second configured grant configuration, and wherein the one or more processors are further configured to cause the UE to:
transmit, to a network node, an indication that the first configured grant configuration is not used for the sidelink communication or the HARQ process identifier.

10. The UE of claim 1, wherein the retransmission of the sidelink communication is transmitted using resources associated with the second configured grant configuration, wherein the first configured grant configuration is associated with one or more uplink resources associated with providing feedback associated with the first configured grant configuration, and wherein the one or more processors are further configured to cause the UE to:
refrain from transmitting feedback associated with the first configured grant configuration and the sidelink communication using a first uplink resource of the one or more uplink resources based at least in part on one or more conditions being met; and
transmit, to a network node, the feedback associated with the first configured grant configuration and the sidelink communication using a second uplink resource of the one or more uplink resources.

11. The UE of claim 1, wherein the one or more processors are further configured to cause the UE to:
receive, from another UE, a feedback communication using a HARQ codebook that is associated with multiple HARQ process identifiers including the HARQ process identifier.

12. The UE of claim 11, wherein the one or more processors are further configured to cause the UE to:
transmit, to the other UE or a network node, a request for HARQ feedback using the HARQ codebook, wherein the feedback communication is received based at least in part on transmitting the request.

13. The UE of claim 1, wherein the one or more processors are further configured to cause the UE to:
transmit, to a network node, an indication of persistent channel access failures based at least in part on a quantity of channel access procedures that are unsuccessful, including the channel access procedure, satisfying a threshold.

14. A network node for wireless communication, comprising:
a memory; and
one or more processors, coupled to the memory, configured to cause the network node to:
transmit, to a first user equipment (UE), configuration information indicating that hybrid automatic repeat request (HARQ) process sharing is enabled and indicating information associated with one or more timers associated with the HARQ process sharing, wherein the configuration information indicates information associated with at least one of a first configured grant configuration or a second configured grant configuration; and
receive, from the first UE, feedback information associated with a sidelink communication that is associated with the first configured grant configuration, wherein the sidelink communication was transmitted via the second configured grant configuration.

15. The network node of claim 14, wherein the one or more processors are further configured to cause the network node to:
receive, from the first UE, an indication of persistent channel access failures based at least in part on a quantity of channel access procedures that are unsuccessful satisfying a threshold; and
perform an action based at least in part on receiving the indication of persistent channel access failures, wherein the action includes causing the first UE to change a bandwidth part, a bandwidth, or a frequency band used by the first UE.

16. A method of wireless communication performed by a user equipment (UE), comprising:
performing a channel access procedure associated with a transmission of a sidelink communication that is to be associated with resources that are associated with a first configured grant configuration, wherein the channel access procedure is unsuccessful, wherein the sidelink communication is associated with a hybrid automatic repeat request (HARQ) process identifier, and wherein a state associated with the HARQ process identifier is changed to pending based at least in part on the channel access procedure being unsuccessful; and
transmitting, based at least in part on successfully performing another channel access procedure, a retransmission of the sidelink communication using resources associated with the first configured grant configuration or a second configured grant configuration based at least in part on the state associated with the HARQ process identifier being changed to pending.

17. The method of claim 16, further comprising:
initiating a timer associated with at least one of the HARQ process identifier or the sidelink communication based at least in part on transmitting the retransmission of the sidelink communication, wherein the timer is associated with an amount of time that the UE is to keep data associated with the sidelink communication stored in a HARQ buffer.

18. The method of claim 17, wherein an amount of time associated with the timer is based at least in part on a periodicity associated with the first configured grant configuration.

19. The method of claim 17, further comprising:
receiving, from a network node, a downlink communication indicating a sidelink grant associated with at least one of the sidelink communication or the HARQ process identifier, wherein the timer is stopped based at least in part on receiving the downlink communication.

20. The method of claim 16, further comprising:
initiating a retransmission timer associated with at least one of the HARQ process identifier or the sidelink communication based at least in part on transmitting the retransmission of the sidelink communication, wherein the retransmission timer is associated with an amount of time after which the UE is to automatically transmit another retransmission of the sidelink communication.

21. The method of claim 20, further comprising:
transmitting another retransmission of the sidelink communication using resources associated with the first configured grant configuration, the second configured grant configuration, or a third configured grant configuration based at least in part on the retransmission timer expiring.

22. The method of claim 16, wherein the retransmission of the sidelink communication is transmitted using resources associated with the second configured grant configuration, and wherein a logical channel priority associated with the first configured grant configuration is modified based at least in part on the channel access procedure being unsuccessful.

23. The method of claim 16, wherein the retransmission of the sidelink communication is transmitted using resources associated with the second configured grant configuration, and the method further comprising:
transmitting, to a network node, an indication that the first configured grant configuration is not used for the sidelink communication or the HARQ process identifier.

24. The method of claim 16, wherein the retransmission of the sidelink communication is transmitted using resources associated with the second configured grant configuration, wherein the first configured grant configuration is associated with one or more uplink resources associated with providing feedback associated with the first configured grant configuration, and the method further comprising:
refraining from transmitting feedback associated with the first configured grant configuration and the sidelink communication using a first uplink resource of the one or more uplink resources based at least in part on one or more conditions being met; and
transmitting, to a network node, the feedback associated with the first configured grant configuration and the sidelink communication using a second uplink resource of the one or more uplink resources.

25. The method of claim 24, wherein the one or more conditions include at least one of:
a quantity of sidelink transmissions associated with the UE being less than a maximum quantity of sidelink transmissions,
sidelink feedback associated with the retransmission having not been received by the UE, or
sidelink feedback associated with the first configured grant configuration having not been received based at least in part on the channel access procedure being unsuccessful.

26. The method of claim 16, further comprising:
receiving, from another UE, a feedback communication using a HARQ codebook that is associated with multiple HARQ process identifiers including the HARQ process identifier.

27. The method of claim 16, further comprising:
transmitting, to a network node, an indication of persistent channel access failures based at least in part on a quantity of channel access procedures that are unsuccessful, including the channel access procedure, satisfying a threshold.

28. A method of wireless communication performed by a network node, comprising:
transmitting, to a first user equipment (UE), configuration information indicating that hybrid automatic repeat request (HARQ) process sharing is enabled and indicating information associated with one or more timers associated with the HARQ process sharing, wherein the configuration information indicates information associated with at least one of a first configured grant configuration or a second configured grant configuration; and
receiving, from the first UE, feedback information associated with a sidelink communication that is associated with the first configured grant configuration, wherein the sidelink communication was transmitted via the second configured grant configuration.

29. The method of claim 28, further comprising:
receiving, from the first UE, a request to grant resources for a second UE for a feedback communication associated with a HARQ codebook that is associated with multiple HARQ process identifiers; and
transmitting, to the second UE, a request to transmit the feedback communication to the first UE and an indication of one or more sidelink resources associated with the feedback communication.

30. The method of claim 28, further comprising:
receiving, from a second UE, a request to grant resources for the second UE for a feedback communication associated with a HARQ codebook that is associated with multiple HARQ process identifiers; and
transmitting, to the second UE, an indication of one or more sidelink resources associated with the feedback communication.
